(19) United States
(12) Patent Application Publication
(10) Pub. No.: US 2009/0115100 A1
(43) Pub. Date: May 7, 2009

(54) METHOD FOR PRODUCING THERMOPLASTIC FILM

(75) Inventors: Shinichi Nakai, Shizuoka (JP); Masaaki Otoshi, Shizuoka (JP); Akihide Fujita, Shizuoka (JP)

Correspondence Address: YOUNG & THOMPSON, 209 Madison Street, Suite 500, ALEXANDRIA, VA, 22314, US

(73) Assignee: FUJIFILM CORPORATION, TOKYO (JP)

(21) Appl. No.: 12/092,740

(22) PCT Filed: Oct. 31, 2006
(86) PCT No.: PCT/JP2006/322204

§ 371 Date: May 6, 2008

(30) Foreign Application Priority Data
Nov. 8, 2005 (JP) 2005-323979

(51) Int. Cl. B29C 55/00

(52) U.S. Cl. 264/291

(57) ABSTRACT

The present invention provides a method for producing a thermoplastic film which makes it possible to improve the optical properties of the thermoplastic film obtained by stretching and a thermoplastic film manufactured thereby. The transverse stretching section in which a cellulose acylate film is transversely stretched includes: a preheating zone, a transverse stretching zone, a cooling zone and a thermal relaxation zone, and the cellulose acylate film having been cooled in the cooling zone is immediately subjected to thermal relaxation treatment in the thermal relaxation zone.

### TECHNICAL FIELD

The present invention relates to a production method for a thermoplastic film, and particularly to a production method for a thermoplastic film used for a liquid crystal display device.

### BACKGROUND ART

Conventionally, a thermoplastic film is stretched to develop an in-plane retardation (Re) and a thickness-direction retardation (Rth), and is used as a phase difference film of a liquid crystal display element to increase a view angle.

As a method for stretching a thermoplastic film of this type, a method of stretching in a longitudinal direction (longitudinal stretching), a method of stretching in a transverse (width) direction (transversal stretching), or a method of stretching in longitudinal and transverse directions simultaneously (sequential biaxial stretching) are known.

Among these, in the sequential biaxial stretching, a film is heated to a temperature higher than the glass transition temperature (Tg) and a pair of nip rollers at an exit side has a conveying speed higher than those at an entrance side, so that the film is stretched in a longitudinal direction. Then, the film is stretched across the width, using a tenter, by heating with both its edges held with clips. If a straight line is drawn on the film surface across the width before feeding the film in the tenter, the line is deformed in the tenter into a concave shape towards the film running direction after the stretching treatment. This phenomenon is called as bowing and known as a factor which makes the physical properties across the width non-uniform.

The reason for the occurrence of the bowing phenomenon is that the middle portion of the film is less bound by clips, compared to the edges which are held by clips, and thus, retardation occurs during continuous stretching. In simultaneous biaxial stretching, too, bowing generally occurs when film width is enlarged transversely, like the above case.

To eliminate this problem, various preventive measures have been proposed. For example, there is proposed in Japanese Patent Application Laid-Open No. 4-74635 inserting a cooling step between a stretching step and a thermosetting step. According to Japanese Patent Application Laid-Open No. 4-74635, the occurrence of bowing can be reduced to some extent.

### DISCLOSURE OF THE INVENTION

However, in the film manufactured by the process proposed in Japanese Patent Application Laid-Open No. 4-74635, its Re and Rth values are so small that it cannot be suitably used as a phase difference plate which is to be incorporated in liquid crystal display devices, and moreover, bowing is too large and the uniformity of Re, Rth and orientation is insufficient. Accordingly, use of the film described in Japanese Patent Application Laid-Open No. 4-74635 as a retardation film of the liquid crystal display device presents the problem of causing non-uniformity in the liquid crystal display screen.

The present invention has been made in the light of the above problem; accordingly its primary object is to provide a method for producing a thermoplastic film which makes it possible to enhance the optical property of the thermoplastic film obtained by stretching and a thermoplastic film obtained thereby.

To achieve the object, a first aspect of the present invention is a method for producing a thermoplastic film, including a stretching step of stretching a thermoplastic film across the width, wherein in the stretching step, a stretching treatment which stretches the thermoplastic film, a cooling treatment which cools the stretched thermoplastic film at a temperature lower than the glass transition temperature Tg, and a thermal relaxation treatment which thermally relaxes the cooled thermoplastic film at a temperature of Tg or higher are consecutively conducted.

After intensive investigation of the above described problem, the inventor of the present invention has found that the thermosetting treatment, which keeps a thermoplastic film at temperatures equal to or higher than Tc (crystallization temperature) to crystallize the resin and is conducted subsequently after the stretching treatment and the cooling treatment in conventional methods for producing a thermoplastic film, significantly decreases the Re and Rth values having been increased by the stretching treatment, adversely affects the occurrence of bowing and is less effective in dimensional stabilization. The present inventor has also found that conducting thermal relaxation treatment subsequently after the stretching treatment and the cooling treatment contributes to improving the Re and Rth values, the occurrence of bowing and the dimensional stability.

According to the first aspect of the present invention, the stretched film is cooled and subjected to thermal relaxation treatment, without thermosetting treatment, to eliminate the strain in the film, whereby the decrease in the Re, Rth values and the occurrence of bowing can be suppressed and the dimensional stability can be improved.

A second aspect of the present invention is the method for producing a thermoplastic film according to the first aspect of the present invention, characterized in that where L1 represents a length of the stretching zone, in which the stretching treatment is conducted, in the thermoplastic film's running direction and L2 represents a length of the cooling zone, in which the cooling treatment is conducted, in the thermoplastic film's running direction, L2/L1 is 0.2 or more and 20 or less. Allowing L2/L1 to fall within the above range makes it possible to suppress the occurrence of bowing more effectively.

A third aspect of the present invention is the method for producing a thermoplastic film according to the first or second aspect of the present invention, characterized in that the thermal relaxation treatment shrinks the width of the thermoplastic film by 0 to 30%. In the present invention, thermal relaxation treatment is preferable which shrinks the width of the film by 0 to 30%. The term “thermal relaxation” herein used means treatment which relaxes the strain in the film and includes the treatment which does not change the width of the film (0%). However, when the thermal relaxation shrinks the width of the film, preferably the degree of the shrinkage is more than 0% and 30% or less.

A fourth aspect of the present invention is the method for producing a thermoplastic film according to any one of the first to third aspects of the present invention, characterized in that in the thermoplastic film having undergone the thermal relaxation treatment, the percent of dimensional change, after it is kept at 60° C. and 90% rh for 24 hours, is ±1% or less both across the width and across the length. According to the present invention, a thermoplastic film can be manufactured in which percent of dimensional change is as small as above.

A fifth aspect of the present invention is the method for producing a thermoplastic film according to any one of the first to fourth aspects of the present invention, characterized in that the thermoplastic film is a saturated norbornene film.

A sixth aspect of the present invention is the method for producing a thermoplastic film according to any one of the first to fourth aspects of the present invention, characterized in that the thermoplastic film is a cellulose acylate film formed using a cellulose acylate resin.

A seventh aspect of the present invention is the method for producing a thermoplastic film according to the sixth aspect of the present invention, characterized in that the cellulose acylate resin is such that the substitution degree of its acylate group satisfies the following expressions:

2.0≦A+B≦3.0

0≦A≦2.0

1.2≦B≦2.9

where A represents the substitution degree of an acetyl group, B the sum of the substitution degrees of propionyl, butylyl, pentanoyl and hexanoyl groups. The cellulose acylate film whose acylate group satisfies such a substitution degree is characterized by a low melting point, ease of stretching and excellent moisture resistance, and thus, a cellulose acylate film can be obtained which excels as a functional film such as a retardation film for liquid crystal display devices.

A eighth aspect of the present invention is the method for producing a thermoplastic film according to any one of the first to seventh aspects of the present invention, characterized in that the stretching treatment is conducted, while holding the edges of the thermoplastic film across the width, to give a 1 to 2.5 times (both inclusive) width. According to the present invention, especially, the occurrence of bowing can be suppressed more effectively when the thermoplastic film is stretched 1 to 2.5 times (both inclusive) with its edges held by clips or the like.

According to the present invention, a thermoplastic film is stretched and cooled, followed by thermal relaxation, without thermosetting treatment, to eliminate the strain in the film, whereby the decrease in the Re, Rth values and the occurrence of bowing can be suppressed and the dimensional stability can be improved.

### BRIEF DESCRIPTION OF THE DRAWINGS

FIG. 1 is a block schematic diagram showing the construction of film manufacturing apparatus to which the present invention is applied;

FIG. 2 is a schematic view showing the construction of an extruder;

FIG. 3 is a schematic view showing the configuration of a transverse stretching section;

FIG. 4A is an illustration of the function of the present invention;

FIG. 4B is an illustration of the function of the present invention; and

FIG. 5 is an illustration of Examples of the present invention.

### DESCRIPTION OF SYMBOLS

10 . . . Film manufacturing apparatus, 12 . . . Cellulose acylate film, 14 . . . Film forming section, 16 . . . Longitudinal stretching section, 18 . . . Transverse stretching section, 20 . . . Winding-up section, 22 . . . Extruder, 24 . . . Die, 26 . . . Drum, T1 . . . Preheating zone, T2 . . . Transverse stretching zone, T3 . . . Cooling zone, T4 . . . Thermal relaxation zone

### BEST MODE FOR CARRYING OUT THE INVENTION

Hereafter, in accordance with the accompanying drawings, preferred embodiment of method for producing a thermoplastic film and a thermoplastic film produced by the method according to the present invention will be described. Note that the present embodiment shows an example of producing a cellulose acylate film as a thermoplastic film, but the present invention is not limited thereto and saturated norbornene resins, polycarbonate resins or the like may be used for the production.

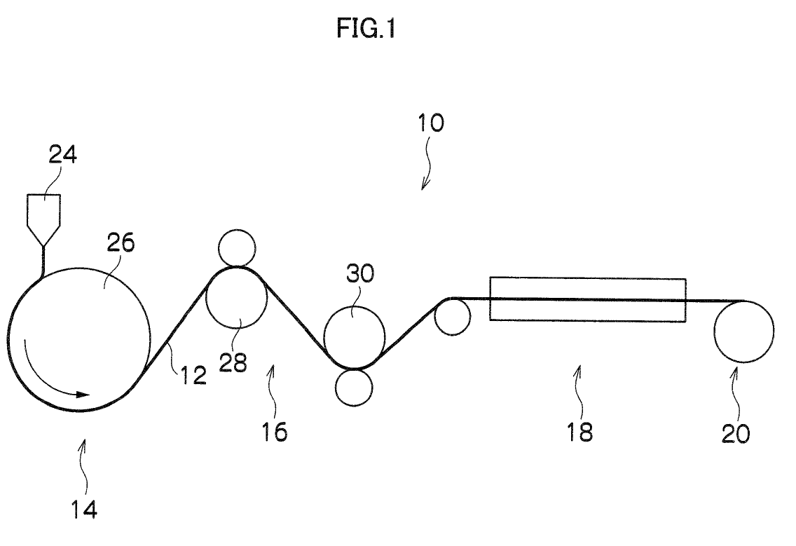

FIG. 1 shows one example of a schematic constitution of an apparatus for producing thermoplastic film. As shown in FIG. 1, a film manufacturing apparatus 10 is made up mainly of a film forming section 14 where a cellulose acylate film 12 before stretched is formed, a longitudinal stretching section 16 and the transverse stretching section 18 where the cellulose acylate film 12 formed in the film forming section 14 is stretched longitudinally and transversely, respectively, and a winding-up section 20 where the cellulose acylate film 12 having been stretched is wound up.

In the film forming section 14, the cellulose acylate resin melted in an extruder 22 is extruded from a die 24 to take the form of a sheet and cast upon a rotating drum 26. The molten resin is cooled and solidified on the surface of the drum 26 to produce a cellulose acylate film 12. The cellulose acylate film is stripped off from the drum 26, fed into the longitudinal stretching section 16 and a transverse stretching section 18 in this order where it is stretched, and wound up into a roll in the winding-up section 20. Through these steps, a stretched cellulose acylate film 12 is manufactured. In the following, each of the sections will be described in detail.

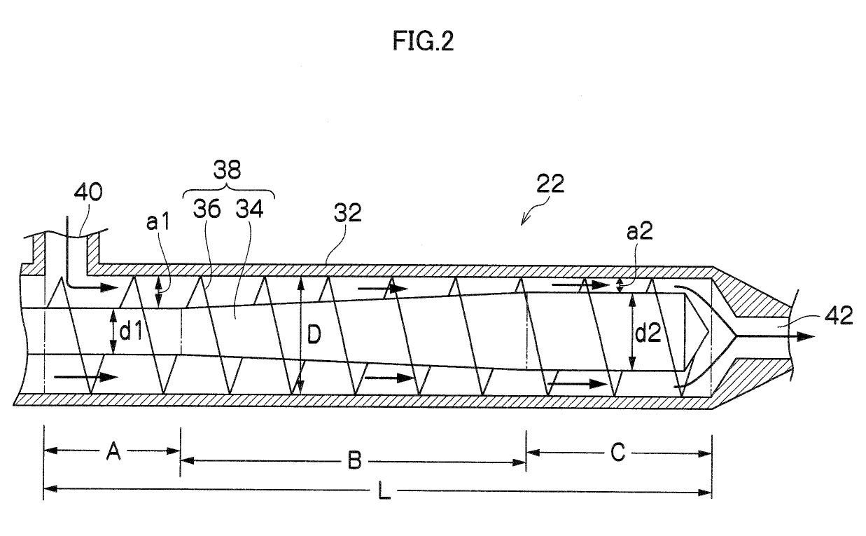

FIG. 2 shows the construction of the extruder 22 in the film forming section 14. As shown in the figure, in a cylinder 32 of the extruder 22 is provided a single shaft screw 38 made up of a screw shaft 34 and a flight 36 mounted thereon, and the single shaft screw 38 is rotated with a motor, not shown in the figure.

On a supply port 40 of the cylinder 32, a hopper, not shown in the figure, is mounted. The cellulose acylate resin is fed from the hopper into the cylinder 32 through the supply port 40.

The cylinder 32 is composed of a supply section (area indicated by A) for conveying a constant amount of cellulose acylate resin supplied from the supply port 40; a compression section (area indicated by B) for kneading and compressing the cellulose acylate resin; and a measurement section (area indicated by C) for measuring the kneaded and compressed cellulose acylate resin, in this order from the supply port 40. The cellulose acylate resin molten by the extruder 22 is continuously fed from a discharge port 42 to the die 24.

A screw compression ratio of the extruder 22 is set to 2.5 to 4.5 and L/D is set to 20 to 50. Here, the screw compression ratio is a volumetric ratio between supply section A and measurement section C, that is, a volume per unit length of supply section A/a volume per unit length of measurement section C. It is calculated by using an outer diameter d1 of the screw shaft 34 of the supply portion A, an outer diameter of d2 of the screw shaft 34 of the measurement section C, a space diameter a1 of supply section A, and a space diameter a2 of the measurement section C. Further, L/D is a ratio of a cylinder length (L) to a cylinder inner diameter (D) in FIG. 2. Furthermore, extrusion temperature is set to 190 to 240° C. When the temperature exceeds 240° C. in the extruder 22, a cooling device (not shown) may be installed between the extruder 22 and the die 24.

The extruder 22 may be either a uniaxial extruder or a biaxial extruder. However, when the screw compression ratio is less than 2.5 and too small, the product cannot be kneaded sufficiently, causing an insoluble portion or insufficient melting of crystal due to small shear heat generation. Thus, after the production, fine crystals are easy to remain in the cellulose acylate film, and further bubbles are easy to be incorporated therein. When a cellulose acylate film 12 is stretched, the remaining crystals inhibit stretching property thereby not to allow the orientation of the film to be sufficiently increased. In contrast, when the screw compression ratio is greater than 4.5 and too large, excessive shear stress is applied and heat is generated, resulting in easy deterioration of the resin. The produced cellulose acylate film is easy to exhibit yellow. Further, the application of excessive shear stress causes molecular cleavages and thus the molecular weight decreases, resulting in inferior mechanical strength of the film. Accordingly, the screw compression ratio is preferably in the range of 2.5 to 4.5, more preferably 2.8 to 4.2, and still more preferably 3.0 to 4.0, in order that the cellulose acylate film produced by the method of the present invention is unlikely to exhibit yellow and cause fracture by stretching.

Further, when the L/D is less than 20 and too small, inadequate melting or kneading occurs and fine crystals are easy to remain in the produced cellulose acylate film in the same manner as the case where the compression ratio is small. In contrast, when the L/D is greater than 50 and too large, the residence time of the cellulose acylate resin in the extruder 22 becomes too long, resulting in easy deterioration of the resin. The long residence time causes molecular cleavage and thus the molecular weight decreases, resulting in inferior mechanical strength of the film. Accordingly, the L/D is preferably in the range of 20 to 50, more preferably 22 to 45, and still more preferably 24 to 40, in order that the cellulose acylate film produced by the method of the present invention is unlikely to exhibit yellow and cause fracture by stretching.

Furthermore, when the extrusion temperature is less than 190° C. and too low, the crystal melting is insufficient and fine crystals are easy to remain in the produced cellulose acylate film. When the cellulose acylate film is stretched, the remaining crystals inhibit stretching property thereby not to allow the orientation of the film to be sufficiently increased. In contrast, when the extrusion temperature is greater than 240° C. and too high, the cellulose acylate resin is deteriorated and the degree of yellowness (YI value) is worsened. Accordingly, the extrusion temperature is preferably in the range of 190° C. to 240° C., more preferably 195° C. to 235° C., and still more preferably 200° C. to 230° C., in order that the cellulose acylate film produced by the method of the present invention is unlikely to exhibit yellow and cause fracture by stretching.

Using the extruder 22 having the above structure, the cellulose acylate resin is molten, the molten resin is continuously supplied to the die 24 and discharged in a sheet shape from a tip (lower end) of the die 24 shown in FIG. 1. The discharged molten resin is cast upon the drum 26, cooled and solidified on the surface of the drum 26, and stripped off from the surface of the drum 26 to produce a cellulose acylate film 12. The cellulose acylate film 12 thus formed is fed into the longitudinal stretching section 16 and the transverse stretching section 18 in this order.

In the following, stretching steps where the cellulose acylate film 12 formed in the film forming section 14 is stretched to give a stretched cellulose acylate film 12 will be described.

A cellulose acylate film 12 is stretched so that molecules in the cellulose acylate film 12 are orientated to allow in-plane retardation (Re) and across-the-thickness retardation (Rth) to develop. The retardation Re, Rth are obtained from the following equations.

Re(nm)=ln(MD)−n(TD)|×T(nm)

Rth(nm)=|{n(MD)+n(TD)/2}−n(TH)|×T(nm)

In the equations, n(MD), n(TD) and n(TH) represent refractive indexes along the longitudinal direction, width direction and thickness direction of the film and T represents thickness in a unit of nm.

As shown in FIG. 1, the cellulose acylate film 12 is first longitudinally stretched in the longitudinal stretching section 16. In the longitudinal stretching section 16, the cellulose acylate film 12 is preheated and the preheated cellulose acylate film 12 is wound around two pairs of nip rolls 28, 30. The nip roll 30 on the outlet side carries the cellulose acylate film 12 at a higher carrying speed than that of the nip roll 28 on the inlet side, whereby the cellulose acylate film 12 is stretched longitudinally.

The preheating temperature in the longitudinal stretching section 16 is preferably (Tg−40° C.) or higher and (Tg+60° C.) or lower, more preferably (Tg−20° C.) or higher and (Tg+40° C.) or lower, and much more preferably Tg or higher and (Tg+30° C.) or lower. The stretching temperature in the longitudinal stretching section 16 is preferably Tg or higher and (Tg+60° C.) or lower, more preferably (Tg+2° C.) or higher and (Tg+40° C.) or lower, and much more preferably (Tg+5° C.) or higher and (Tg+30° C.) or lower. The draw ratio in the longitudinal stretching is preferably 1.01 or higher and 3 or lower, more preferably 1.05 or higher and 2.5 or lower, and much more preferably 1.1 or higher and 2 or lower.

The cellulose acylate film 12 having been longitudinally stretched is fed into the transverse stretching section 18, where it is stretched across the width. In the transverse stretching section 18, for example, a tenter is preferably used. The cellulose acylate film 12 is stretched transversely in a tenter with both its edges across the width held by clips. This transverse stretching further increases the retardation Rth.

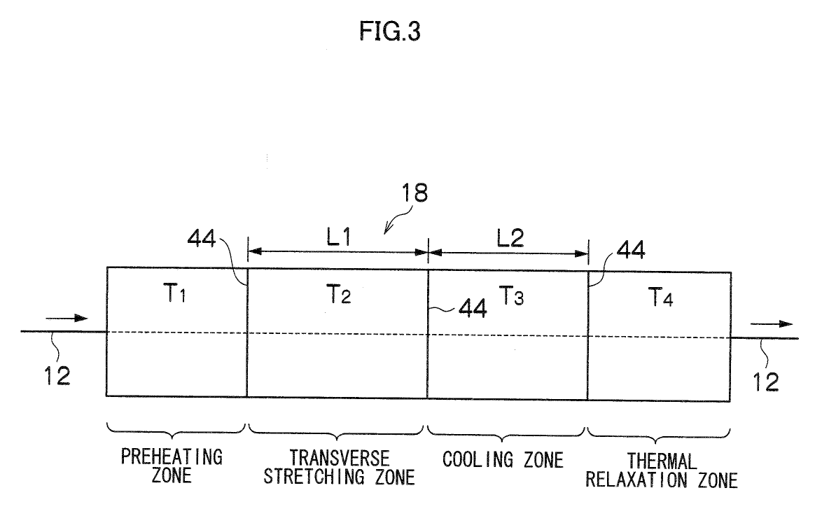

FIG. 3 is a schematic view showing the zone configuration of the transverse stretching section 18. The transverse stretching section 18 is made up of a number of zones divided with a windshield curtain 44, and the temperature of each zone can be controlled with hot air etc. The zones include: from the inlet side towards outlet side, a preheating zone T1 where the cellulose acylate film 12 undergoes preheating treatment before undergoing transverse stretching; a transverse stretching zone T2 where the cellulose acylate film 12 undergoes transverse stretching; a cooling zone T3 where the cellulose acylate film 12 having undergone transverse stretching undergoes cooling treatment; and the thermal relaxation zone T4 where the cellulose acylate film 12 undergoes relaxation treatment.

The cellulose acylate film 12 runs from the inlet side with both its edge across the width held by clips (not shown in the figure). And the cellulose acylate film 12 is first preheated in the preheating zone T1. The zone temperature (preheating temperature) of the preheating zone T1 is preferably (Tg−20° C.) or higher and (Tg+80° C.) or lower, more preferably (Tg−5° C.) or higher and (Tg+40° C.) or lower, and much more preferably Tg or higher and (Tg+30° C.) or lower.

The cellulose acylate film 12 having been preheated in the preheating zone T1 is moved to the transverse stretching zone T2. In the transverse stretching zone T2, the cellulose acylate film 12 is allowed to undergo transverse stretching treatment by increasing the distance between clips by which both the edges of the film across the width are being held. The zone temperature (stretching temperature) of the transverse stretching zone T2 is preferably (Tg−10° C.) or higher and (Tg+50° C.) or lower, more preferably (Tg−5° C.) or higher and (Tg+40° C.) or lower, and much more preferably Tg or higher and (Tg+30° C.) or lower. The draw ratio in the transverse stretching treatment is preferably 1.0 or higher and 2.5 or lower, more preferably 1.05 or higher and 2.3 or lower, and much more preferably 1.1 or higher and 2 or lower.

The cellulose acylate film 12 having undergone transverse stretching in the transverse stretching zone T2 is cooled in the cooling zone T3. Cooling, in the cooling zone T3, the cellulose acylate film 12 right after undergoing transverse stretching in the transverse stretching zone T2 makes it possible to suppress the occurrence of bowing effectively. The temperature of the cooling zone T3 is preferably lower than Tg, more preferably (Tg−50° C.) or higher and (Tg−2° C.) or lower, and much more preferably (Tg−30° C.) or higher and (Tg−5° C.) or lower. The cooling zone T3 is set so that where L2 represents the length of the cellulose acylate film 12 in the running direction and L1 the length of the transverse stretching zone T2, the ratio L2/L1 is 0.2 or larger and 20 or smaller. If L2/L1 is smaller than 0.2, the bowing suppressing effect of the cooling zone is decreased, whereby bowing cannot be suppressed reliably. Conversely, if L2/L1 is larger than 20, the apparatus is made large size, and moreover, the improvement in bowing suppressing effect cannot be expected. Thus, allowing L2/L1 to be 0.2 or larger and 20 or smaller makes it possible to obtain efficient bowing suppressing effect of the cooling zone T3.

The cellulose acylate film 12 having been cooled in the cooling zone T3 is moved to the thermal relaxation zone T4. In the thermal relaxation zone T4, the film undergoes heat treatment while being allowed to be in the relaxed state, whereby the residual stress or strain components within the cellulose acylate film 12 are removed. The temperature of the thermal relaxation zone T4 is preferably Tg or higher, more preferably Tg or higher and (Tg+50° C.) or lower, and much more preferably Tg or higher and (Tg+30° C.) or lower. In the thermal relaxation treatment, the shrinkage, across the width, of the cellulose acylate film 12 is preferably 0% or higher and 30% or lower, more preferably higher than 0% and 20% or lower, and much more preferably 0.1 to 15%. In the present invention, the term “thermal relaxation” means “a step of removing (relaxing) the stress or strain in a film by subjecting the film to heat treatment (preferably in conditions where the tension of the film is eased)” and it has different meaning from that of “thermosetting”, that is, “a step of accelerating the crystallization of a film by heat treating the film at temperatures equal to or higher than crystallization temperature in conditions where the set draw ratio at the time of stretching is maintained or the film is tensed by binding”.

In the following, the function of the transverse stretching section 18 made up as above will be described.

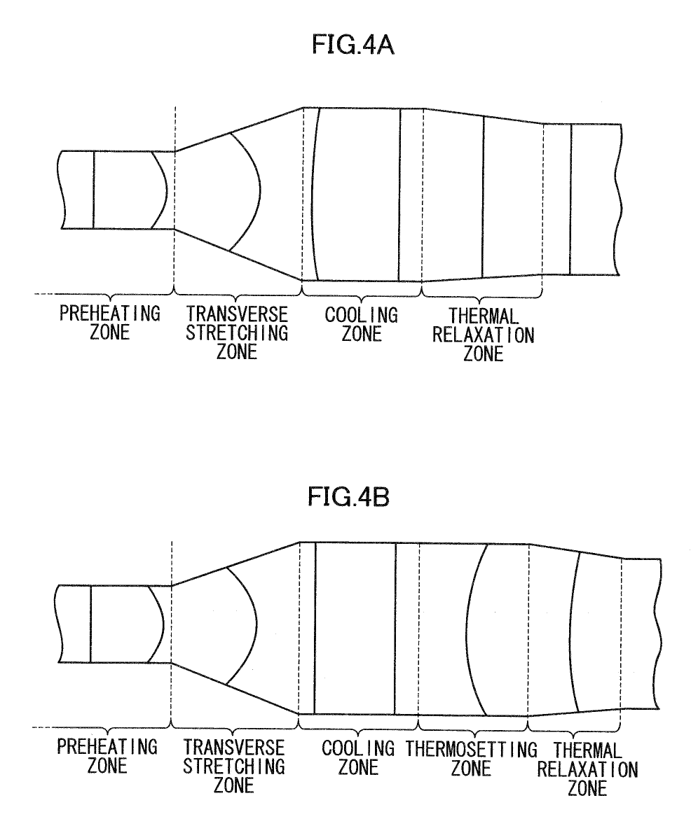

FIGS. 4A and 4B are illustrations of the function of the present invention. FIG. 4A shows the state where bowing occurs in the present invention, while FIG. 4B shows the state where bowing occurs in Comparative Example, in which thermosetting zone is provided between the cooling zone T3 and the thermal relaxation zone T4 to conduct thermosetting treatment.

As shown in FIG. 4B, in Comparative Example, the degree of the convex bowing occurring at an earlier stage in the transverse stretching zone T2 is decreased in the cooling zone T3. In Comparative Example, however, since thermosetting treatment is conducted after cooling treatment and before thermal relaxation treatment, the degree of bowing is increased and the values Re, Rth are decreased. Thus, in the cellulose acylate film 12 of Comparative Example, orientation angle distribution occurs across the width, and because of the orientation angle distribution and small Re, Rth values, the film of Comparative Example is not suitable to be used as a high functional film for optical application.

Contrary, in Example of the present invention, the cellulose acylate film 12 undergoes thermal relaxation treatment in the thermal relaxation zone T4 subsequently and immediately after cooling treatment in the cooling zone T3, as shown in FIG. 4A. The cellulose acylate film 12 undergoes 0 to 30% thermal shrinkage across the width by the thermal relaxation treatment, whereby the residual stress or strain in the cellulose acylate film 12 is removed.

Conducting the thermal relaxation treatment of the cellulose acylate film 12 immediately after the cooling treatment makes it possible to remove the residual stress or strain in the cellulose acylate film 12 without decreasing the Re, Rth of the film and while keeping the degree of bowing small, thereby improving the dimensional stability of the film. Thus, the percent of dimensional change of the cellulose acylate film 12 both across the width and across the length can be kept within ±1% at the outlet of the thermal relaxation zone T4 (conditions: temperature 60° C., humidity 90%, keeping time 24 hours).

As described above, transverse and longitudinal stretching treatment provides a stretched cellulose acylate 12 in which retardations Re, Rth have developed. In the stretched cellulose acylate film 12, preferably Re is 0 nm or larger and 500 nm or smaller, more preferably 10 nm or larger and 400 nm or smaller, and much more preferably 15 nm or larger and 500 nm or smaller and Rth is 30 nm or larger and 500 nm or smaller, more preferably 50 nm or larger and 400 nm or smaller, and much more preferably 70 nm or larger and 350 nm or smaller. More preferably, the cellulose acylate film 12 satisfies Re≦Rth, and much more preferable Re×2≦Rth. To realize high Rth and low Re, it is preferable to stretch the cellulose acylate film 12 having undergone longitudinal stretching transversely (across the width). The reason is that since the difference in the in-plane retardation (Re) is the difference between orientation across the length and orientation across the width, stretching the cellulose acylate film 12 not only in a longitudinal direction but in a transverse direction, which is perpendicular to the longitudinal direction, decreases the difference between orientation across the length and orientation across the width, thereby decreasing the planar orientation (Re). On the other hand, stretching the cellulose acylate film 12 not only longitudinally but transversely increases the area ratio, whereby the orientation across the thickness increases with the decrease in thickness, resulting in increase in Rth.

Preferably the changes in Re, Rth with changes in location across the width and across the length are kept 5% or less, more preferably 4% or less, and much more preferably 3% or less. Preferably the orientation angle is 90°±5° or smaller or 0°±5° or smaller, more preferably 90°±3° or smaller or 0°±3° or smaller, and much more preferably 90°±1° or smaller or 0°±1° or smaller. If stretching treatment, like that of the present invention, is conducted under these conditions, the degree of bowing can be decreased. Preferably bowing distortion is 10% or smaller, more preferably 5% or smaller and much more preferably 3% or smaller. The bowing distortion is obtained by dividing, by the width of the cellulose acylate film 12, the deviation of the straight line drawn across the width on the surface of the film before the film is fed into a tenter, which is caused in the middle portion of the cellulose acylate film 12 because of the distortion of the line into concave after completion of stretching treatment.

The cellulose acylate film 12 having undergone stretching treatment is wound up into a roll in the winding-up section 20 of FIG. 1.

In the following, cellulose acylate resins suitably used in the present invention, a film forming process for forming a cellulose acylate film 12 before stretching, and methods for processing a cellulose acylate film 12 will be described in detail following the procedures.

### (Cellulose Acylate Resin)

The cellulose acylates used in the present invention preferably have the following characteristic.

The cellulose acylate films in which acylate groups satisfy the following degree of substitution (A represents the degree of substitution of acetyl group and B represents the sum of the degrees of substitution of propionyl, butylyl, pentanoyl and hexanoyl groups).

2.5≦A+B<3.0

1.25≦B<3

Preferably, when propionyl group accounts for ½ or more of B, acylate groups satisfy the following degree of substitution,

2.6≦A+B≦2.95

2.0≦B≦2.95

and when propionyl group accounts for less than ½ of B, they satisfy the following degree of substitution.

2.6≦A+B≦2.95

1.3≦B≦2.5

More preferably, when propionyl group accounts for ½ or more of B, acylate groups satisfy the following degree of substitution,

2.7≦A+B≦2.95

2.4≦B≦2.9

and when propionyl group accounts for less than ½ of B, acylate groups satisfy the following degree of substitution.

2.7≦A+B≦2.95

1.3≦B≦2.0

The present invention is characterized in that the substitution degree of acetyl groups in acyl groups is reduced, and the sum of the substitution degrees of propionyl groups, butyryl groups, pentanoyl groups and hexanoyl groups is increased. This can reduce Re and Rth variations over time after stretching. Further, this allows these groups longer than acetyl group to be present in more amounts in the film, and thereby the film can obtain improved flexibility and enhanced stretching property. Therefore, the orientation of cellulose acylate molecules is hardly disturbed as the stretching is carried out, which reduces temporal changes of Re and Rth appeared thereby. However, if an acyl group is longer than the above ones, it is not preferred since a glass transition temperature (Tg) and elastic modulus suffer too large decrease. Thus, propionyl, butylyl, pentanoyl and hexanoyl groups, which are larger than acetyl group, are preferable, propionyl and butylyl groups are more preferable, and butylyl group is much more preferable.

The fundamental principle of the synthesis method of such cellulose acylate is described in Migita et al., “Mokuzai Kagaku (Chemistry of Wood Material)”, pp. 180-190 (published by Kyoritsu Shuppan Co., Ltd., 1968). A typical synthesis method is a liquid-phase acetifying method using a carboxylic acid anhydride, acetic acid and a sulfuric acid catalyst. Specifically, a cellulose material such as an cotton linter or wood pulp is subjected to a pretreatment with an appropriate amount of acetic acid and then poured into a carboxylating mixture cooled beforehand for esterification and thereby synthesize complete cellulose acylate (the sum of the acyl substitution degrees at the 2-, 3- and 6-positions is about 3.00). The aforementioned carboxylating mixture generally contains acetic acid as a solvent, carboxylic acid anhydride as an esterification agent and sulfuric acid as a catalyst. The carboxylic acid anhydride is usually used in a stoichiometrically excessive amount with respect to the total amount of cellulose, which reacts with the anhydride, and water present in the system. After completion of the acylation reaction, an aqueous solution of a neutralizing agent (e.g., carbonate, acetate or oxide of calcium, magnesium, iron, aluminum or zinc) is added to the system in order to hydrolyze excessive carboxylic acid anhydride remaining in the system and neutralize a part of the esterification catalyst remaining in the system. Then, the obtained complete cellulose acylate is kept at 50 to 90° C. in the presence of a small amount of an acetylation reaction catalyst (usually the remaining sulfuric acid) so that the cellulose acylate should be saponified, ripened and thereby converted into cellulose acylate having desired acyl substitution degree and polymerization degree. When the desired cellulose acylate is obtained, the cellulose acylate solution is poured into water or diluted sulfuric acid (or water or diluted sulfuric acid is poured into the cellulose acylate solution) after completely neutralizing the catalyst remaining in the system with such as a neutralizing agent as described above or without such neutralization to separate the cellulose acylate. This resultant product is washed and subjected to stabilization treatment to yield cellulose acylate.

The degree of polymerization of cellulose acylate preferably used in the present invention is 200 to 700, preferably 250 to 550, more preferably 250 to 400, and particularly preferably 250 to 350, in terms of viscosity average polymerization degree. The viscosity average polymerization degree can be determined by the intrinsic viscosity method by Uda et al. (Kazuo Uda, Hideo Saito: Journal of the Society of Fiber Science, Vol. 18, No. 1, 105-120, 1962). The details are described in Japanese Patent Application Laid-Open No. 9-95538.

The viscosity average polymerization degree can also be adjusted by removing low-molecular-weight components. Removing low-molecular-weight components is useful because it makes the viscosity small compared with that of ordinary cellulose acylates, though it increases the average molecular weight (degree of polymerization). Low-molecular-weight components can be removed by washing the cellulose acylate with an appropriate organic solvent. The molecular weight can also be adjusted by polymerization method. For example, when manufacturing a cellulose acylate containing a smaller amount of low-molecular-weight components, it is preferable to adjust the amount of sulfuric acid catalyst in the oxidation reaction to 0.5 to 25 parts by mass per 100 parts by weight of cellulose. If the amount of sulfuric acid catalyst falls within the above range, a cellulose acylate can be synthesized which is preferable in terms of molecular weight distribution (uniform in molecular weight distribution).

In the cellulose acylates preferably used in the present invention, preferably the ratio of weight average molecular weight Mw to number average molecular weight Mn is 1.5 to 5.5, more preferably 2.0 to 5.0, particularly preferably 2.5 to 5.0, and most preferably 3.0 to 5.0.

These cellulose acylates may be used alone or in the form of a mixture of two or more kinds. A cellulose acylate into which high-molecular-weight components, other than cellulose acylates, are properly mixed may also be used. As high-molecular-weight components to be mixed into a cellulose acylate, those highly compatible with cellulose ester are preferable. And preferably high-molecular-weight components to be mixed in a cellulose acylate allow the resultant film to have a transmittance of 80% or more, more preferably 90% or more, and much more preferably 92% or more.

In the present invention, addition of plasticizer is preferable because it can decrease the change in Re, Rth with time. The reason the change in Re, Rth with time is decreased is that the addition of plasticizer makes cellulose acylates hydrophobic, whereby the relaxation of cellulose acylate molecule stretching orientation caused by water absorption can be suppressed. Examples of plasticizer include: alkyl phthalyl alkyl glycolates; phosphate esters; and carboxylate esters.

Examples of alkylphthalylalkyl glycolates include methylphthalylmethyl glycolate, ethylphthalylethyl glycolate, propylphthalylpropyl glycolate, butylphthalylbutyl glycolate, octylphthalyloctyl glycolate, methylphthalylethyl glycolate, ethylphthalylmethyl glycolate, ethylphthalylpropyl glycolate, methylphthalylbutyl glycolate, ethylphthalylbutyl glycolate, butylphthalylmethyl glycolate, butylphthalylethyl glycolate, propylphthalylbutyl glycolate, butylphthalylpropyl glycolate, methylphthalyloctyl glycolate, ethylphthalyloctyl glycolate, octylphthalylmethyl glycolate and octylphthalylethyl glycolate.

Examples of phosphate esters include: triphenyl phosphate, tricresil phosphate and phenyl diphenyl phosphate. Preferably phosphate ester plasticizers are used which are described in the third to seventh aspects of National Publication of International Patent Application No. 6-501040.

Examples of carboxylate esters include: phthalate esters such as dimethyl phthalate, diethyl phthalate, dibutyl phthalate, dioctyl phthalate and diethylhexyl phthalate; citrate esters such as acetyl trimethyl citrate, acetyl triethyl citrate and acetyl tributyl citrate; and adipate esters such as dimethyl adipate, dibutyl adipate, diisobutyl adipate, bis(2-ethylhexyl)adipate, diisodecyl adipate and bis(butyl diglycol adipate). Preferably, butyl oleate, methyl acetyl ricinoleate, dibutyl sebacate or triacetin is used alone or in combination with other plasticizer.

Preferably the content of the plasticizer in cellulose acylate film is 0% by weight or larger and 20% by weight or smaller, more preferably 1% by weight or larger and 20% by weight or smaller, and much more preferably 2% by weight or larger and 15% by weight or smaller. Two or more kinds of these plasticizers may be used depending on the situation.

In addition to the plasticizers, various additives (e.g., a UV protective agent, a deterioration inhibitor, an optical anisotropy-controlling agent, fine particles, an IR absorbent, a surfactant and a smell-trapping agent (e.g., amines) can be added. As the IR absorbent, usable are those mentioned in Japanese Patent Application Laid-Open No. 2001-194522, and as the UV protective agent, usable are those mentioned in Japanese Patent Application Laid-Open No. 2001-151901, and they are preferably incorporated in an amount of from 0.001% by mass to 5% by mass of cellulose acylate. As the fine particles, those having an average particle size of 5 to 3000 nm are preferably used, and those consisting of metal oxide or crosslinked polymer are usable. The fine particles are preferably incorporated in an amount of 0.001% by mass to 5% by mass of cellulose acylate. Preferably the content of deterioration inhibitor in cellulose acylate is 0.0001 to 2% by mass. As the optical anisotropy-controlling agent, those mentioned in Japanese Patent Application Laid-Open Nos. 2003-66230 and 2002-49128 are usable. The optical anisotropy-controlling agent is preferably incorporated in an amount of 0.1% by mass to 15% by mass of cellulose acylate.

### (Melt-Cast Film Formation)

### (1) Drying

Cellulose acylate resin may be used in the form of powder, but preferably in the form of pellet for reducing thickness fluctuation in forming a film.

The water content of the cellulose acylate resin is adjusted to preferably 1% or less, more preferably 0.5% or less, much more preferably 0.1% or less, and then thrown into a hopper. In this occasion, the temperature of the hopper is adjusted preferably to a temperature from Tg−50° C. to Tg+30° C., more preferably from Tg−40° C. to Tg+10° C., much more preferably from Tg−30° C. to Tg. Thus, re-adsorption of moisture within the hopper can be depressed, and efficiency of the above-described drying can be more easily ensured. Further, it is preferred to blow a dehydrated air or an inert gas (e.g. nitrogen) into the hopper.

### (2) Knead Extrusion

Knead-melting is conducted at a temperature of from 190° C. to 240° C., more preferably from 195° C. to 235° C., much more preferably from 200° C. to 230° C. In this occasion, the melting temperature may be at a definite level, or may be controlled by dividing into several levels. The kneading time is preferably from 2 minutes to 60 minutes, more preferably from 3 minutes to 40 minutes, particularly preferably from 4 minutes to 30 minutes. Further, it is also preferred to conduct knead-melting while blowing an inert stream (e.g. nitrogen) in the inside of the extruder or evacuating by using an extruder equipped with a vent.

### (3) Casting

The molten cellulose acylate resin is introduced into a gear pump and, after removing pulsation of the extruder, filtered through a metal-mesh filter, then extruded in a sheet form onto a cooling drum through a T-shaped die installed after the filter. The extrusion may be conducted in a single layer or in plural layers using a multi-manifold die or a feedblock die. In this occasion, unevenness in thickness in the transverse direction can be adjusted by controlling an opening of the die lip.

Thereafter, the resultant product is extruded onto the cooling drum. In this operation, it is preferable to improve the adhesion of the melt extruded sheet to the cooling drum using a method such as electrostatic application, air-knife, air-chamber, vacuum nozzle or touch roll method. Such an adhesion improving method may be applied to the whole surface of the melt extruded sheet or part of the same (e.g. both edges alone).

The cooling drum and the endless metal belt capable of running with a stretched state preferably have a temperature from 60° C. to 160° C., more preferably 70° C. to 150° C., much more preferably 80° C. to 140° C. Thereafter, the extruded sheet is stripped off from the cooling roll, introduced between nip rolls and into a tenter, and then taken up. The take-up rate is preferably from 10 m/min to 100 m/min, more preferably from 15 m/min to 80 m/min, much more preferably from 20 m/min to 70 m/min.

The filming width is preferably from 1 m to 5 m, more preferably from 1.2 m to 4 m, much more preferably from 1.3 m to 3 m. The thickness of the thus-obtained non-stretched cellulose acylate film is preferably from 30 μm to 400 μm, more preferably from 40 μm to 300 μm, much more preferably from 50 μm to 200 μm.

The thus-obtained cellulose acylate film 12 is preferably trimmed at both ends and once taken up by a wind-up machine. The trim may be re-used as a material for producing the same kind of cellulose acylate film or a different kind of cellulose acylate film by subjecting it to a pulverizing treatment and, as needed, to a granulating treatment or a treatment of depolymerization and re-polymerization. It is also preferred, in view of preventing scratches, to provide a lamifilm on at least one surface of the film before being taken up.

The thus-obtained cellulose acylate film preferably has a glass transition temperature (Tg) from 70° C. to 180° C., more preferably from 80° C. to 160° C., much more preferably from 90° C. to 150° C.

### (Processing of Cellulose Acylate Film)

The cellulose acylate film formed by the above method is stretched uniaxially or biaxially by the above method to prepare a stretched cellulose acylate film. This film may be used alone, or may be used in combination with a polarizing plate, after providing a liquid crystal layer, refractive index controlled layer (low reflection layer), or hard coat layer thereupon. These members can be provided by the steps explained below.

### (1) Surface Treatment

The cellulose acylate film can be subjected to a surface treatment to improve adhesion to various functional layers (e.g., undercoat layer and back layer). For example, a glow discharge treatment, UV ray irradiation treatment, corona treatment, flame treatment or treatment with an acid or an alkali may be employed. The glow discharge treatment may be a plasma treatment using a low-temperature plasma generated under a low-pressure gas of 10⁻³ to 10⁻²⁰ Torr or may be a plasma treatment under atmospheric pressure. A plasma-generating gas is a gas which generates a plasma under the above-mentioned conditions, and examples thereof include argon, helium, neon, krypton, xenon, nitrogen, carbon dioxide, flons such as tetrafluoromethane, and mixtures thereof. Detailed descriptions thereon are given in Journal of Technical Disclosure (Kogi No. 2001-1745, published by Japan Institute of Invention and Innovation on Mar. 15, 2001) on pages 30 to 32. Additionally, plasma treatment under atmospheric pressure which has been noted in recent years employs an irradiation energy of, for example, from 20 to 500 Kgy under 10 to 1,000 Kev, more preferably from 20 to 300 Kgy under 30 to 500 Kev. Among these, an alkali saponification treatment is particularly preferred.

The alkali saponification treatment may be conducted by dipping in a saponifying solution (dipping method) or by coating a saponifying solution (coating method). In the case of the dipping method, the treatment can be performed by passing the film through an aqueous solution of NaOH, KOH or the like having pH of 10 to 14 and heated to 20° C. to 80° C. in a tank for 0.1 to 10 minutes, followed by neutralization, washing with water and drying.

With the coating method, there may be employed a dip coating method, a curtain coating method, an extrusion coating method, a bar coating method or an E-type coating method. As the solvent for the coating solution to be used for the alkali saponification treatment, it is preferable to select a solvent which has a good wetting property for application of saponification liquid to a transparent supporting body and which can keep a good surface state without forming unevenness on the surface of the transparent supporting body. Specifically, alcoholic solvents are preferred, with isopropyl alcohol being particularly preferred. It is also possible to use an aqueous solution of a surfactant as the solvent. The alkali to be used in the coating solution for alkali saponification treatment is preferably an alkali which dissolves in the above-described solvent, and KOH and NaOH are particularly preferred. The pH of the coating solution for saponification treatment is preferably 10 or more, more preferably 12 or more. The reaction time for the alkali saponification is preferably from 1 second to 5 minutes, more preferably from 5 seconds to 5 minutes, particularly preferably from 20 seconds to 3 minutes, at room temperature. After completion of the alkali saponification reaction, the saponification solution-coated surface is preferably washed with water or with an acid then water. It is also possible to continuously conduct the saponification treatment by the coating method and application of an oriented film to be described hereinafter, which contributes to reduction of the number of steps. These saponification methods are specifically described in, for example, Japanese Patent Application Laid-Open No. 2002-82226 and National Publication of International Patent Publication No. 02/46809.

It is also preferred to provide an undercoat layer for adhesion to a functional layer. This undercoat layer may be provided by coating after the above-mentioned surface treatment or may be provided without the surface treatment. Detailed descriptions on the undercoat layer are given in Journal of Technical Disclosure (Kogi No. 2001-1745, published by Japan Institute of Invention and Innovation on Mar. 15, 2001) on page 32.

The surface treatment and the undercoating step can be provided at the final stage of the filming process, and may be conducted independently or during the step of providing a functional layer to be described hereinafter.

### (2) Providing Functional Layer

It is preferred to combine the cellulose acylate film formed by the above methods with functional layers described in detail in Journal of Technical Disclosure (Kogi No. 2001-1745, published by Japan Institute of Invention and Innovation on Mar. 15, 2001) on pages 32 to 45. Among them, providing a polarizing layer (to form a polarizing plate), providing an optical compensatory layer (to form an optical compensatory film) and providing an antireflective layer (to form an antireflective film) are preferred.

### (A) Providing Polarizing Film (Preparation of Polarizing Plate)

### (A-1) Materials to be Used

At present, commercially available polarizing layers are generally prepared by dipping a stretched polymer in a solution of iodine or a dichroic dye retained in a tank to thereby permeate iodine or the dichroic dye into a binder. As the polarizing film, a coated polarizing film represented by that produced by Optiva Inc. may also be used. Iodine and the dichroic dye in the polarizing film are oriented in the binder to exhibit their polarizing ability. As the dichroic dyes, azo dyes, stilbene dyes, pyrazolone dyes, triphenylmethane dyes, quinoline dyes, oxazine dyes, thiazine dyes or anthraquinone dyes are used. The dichroic dyes are preferably water-soluble. The dichroic dyes preferably have a hydrophilic substituent (e.g., a sulfo group, an amino group or a hydroxyl group). Examples thereof include those compounds described in Journal of Technical Disclosure (Kogi No. 2001-1745, published on Mar. 15, 2001, p. 58).

As the binder to be used for the polarizing film, both a polymer which itself can cause cross-linking and a polymer which can be linked with a cross-linking agent may be used, and a plurality of combinations thereof may be used. The binder includes methacrylate copolymers, styrenic copolymers, polyolefins, polyvinyl alcohol and modified polyvinyl alcohols, poly(N-methylolacrylamide), polyesters, polyimides, vinyl acetate copolymers, carboxymethyl cellulose and polycarbonates described in, for example, Japanese Patent Application Laid-Open No. 8-338913, paragraph [0022]. A silane coupling agent may also be used as the polymer. As the polymer to be used for the polarizing film, water-soluble polymers (e.g., poly(N-methylolacrylamide), carboxymethyl cellulose, gelatin, polyvinyl alcohol and modified polyvinyl alcohols) are preferred. More preferred are gelatin, polyvinyl alcohol and modified polyvinyl alcohols, and still more preferred are polyvinyl alcohol and modified polyvinyl alcohols. It is particularly preferred to use two polyvinyl alcohols or modified polyvinyl alcohols different from each other in polymerization degree. The saponification degree of the polyvinyl alcohol is preferably from 70 to 100%, more preferably from 80 to 100%. The polymerization degree of the polyvinyl alcohol is preferably from 100 to 5,000. As the modified polyvinyl alcohols, descriptions thereon are given in Japanese Patent Application Laid-Open Nos. 8-338913, 9-152509, and 9-316127. The polyvinyl alcohol and modified polyvinyl alcohols may be used in combination of two or more thereof.

The lower limit of the thickness of the binder is preferably 10 μm. In view of light leakage of a crystal liquid display device, a smaller thickness of the binder is more preferred, and the upper limit thereof is preferably equal to or smaller than the thickness of the at presently commercially available polarizing plate (about 30 μm), more preferably equal to or smaller than 25 μm, particularly preferably equal to or smaller than 20 μm.

The binder to be used for the polarizing film may be cross-linked. A polymer or monomer having a cross-linkable functional group may be mixed with the binder, and a cross-linkable functional group may be given to the binder polymer itself. Cross-linking may be caused by light, heat or change in pH to form a binder having a cross-linked structure. As to the cross-linking agent, descriptions are given in US Reissued Pat. No. 23,297. Also, a boron compound (e.g., boric acid or borax) may be used as the cross-linking agent. The addition amount of the cross-linking agent for the binder is preferably from 0.1 to 20% by mass based on the weight of the binder. Cross-linking of the polymer serves to improve orientation properties as a polarizing element and resistance to humidity and heat of the polarizing film.

The amount of the unreacted cross-linking agent at the completion of the cross-linking reaction is preferably 1.0% by mass or less, more preferably 0.5% by mass or less. Such amount serves to improve weatherability.

### (A-2) Stretching of Polarizing Layer

The polarizing film is preferably dyed with iodine or a dichroic dye after being stretched (stretching method) or being rubbed (rubbing method).

With the stretching method, the stretch ratio is preferably from 2.5 to 30.0 times, more preferably from 3.0 to 10.0 times. The stretching can be conducted by dry stretching in the air. Also, wet stretching may be employed in a state of being dipped in water. The stretch ratio in the dry stretching is preferably from 2.5 to 5.0 times, and the stretch ratio in the wet stretching is preferably from 3.0 to 10.0 times. The stretching may be conducted in a direction parallel to the MD direction (parallel stretching) or in a slant direction (slant stretching). Such stretching may be completed by one stretching procedure or by several stretching procedures. Stretching by several stretching procedures serves to more uniformly stretch even at a high stretch ratio.

### a) Method of Stretching in Parallel Direction

The PVA film is swollen prior to stretching. The swelling ratio (ratio of weight after swelling to weight before swelling) is from 1.2 to 2.0 times. Thereafter, the film is stretched in an aqueous medium bath or in a dying bath containing a dichroic substance dissolved therein at a bath temperature of from 15° C. to 50° C., particularly from 17° C. to 40° C. while contentiously conveying through guide rolls, etc. Stretching can be performed by gripping the film using two pairs of nip rolls, with the conveying speed of the nip rolls at the latter position being larger than that of the nip rolls at the former position. The stretch ratio is based on the ratio of the length after stretching/the initial length (hereinafter the same) and, in view of the aforesaid operational effects, the stretch ratio is preferably from 1.2 to 3.5 times, particularly preferably from 1.5 to 3.0 times. Thereafter, the film is dried at a temperature of from 50° C. to 90° C. to obtain a polarizing film.

### b) Method of Stretching in Slant Direction

As this method, there may be employed a method, described in Japanese Patent Application Laid-Open No. 2002-86554, of stretching in a slant direction by using a tenter which overhangs in the slant direction. Since this stretching is conducted in the air, it is necessary to incorporate water therein before stretching. The water content is preferably from 5% to 100%, more preferably from 10% to 100%.

The temperature upon stretching is preferably from 40° C. to 90° C., more preferably from 50° C. to 80° C. The humidity is preferably from 50% rh to 100% rh, more preferably from 70% rh to 100% rh, still more preferably from 80% rh to 100% rh. The traveling speed in the longitudinal direction is preferably equal to or higher than 1 m/min, more preferably equal to or higher than 3 m/min. After completion of the stretching, the film is dried at a temperature of from 50° C. to 100° C., preferably from 60° C. to 90° C., for a period of from 0.5 minutes to 10 minutes, more preferably from 1 minute to 5 minutes.

The absorption axis of the thus-obtained polarizing film is preferably from 10° to 80°, more preferably from 30° to 60°, still more preferably substantially 45° (40° to 50°).

### (A-3) Lamination

The saponified cellulose acylate film and the stretched polarizing layer are laminated to each other to prepare a polarizing plate. The lamination is preferably conducted so that the angle between the direction of conveying the cellulose acylate film and the direction of stretching axis of the polarizing layer becomes 45°.

An adhesive for lamination is not particularly limited, and examples thereof include PVA-based resins (including modified PVA having an acetacetyl group, sulfonic acid group, carboxylic acid group or oxyalkylene group) and an aqueous solution of a boron-containing compound. Among them, the PVA-based resins are preferred. The dry thickness of the adhesive layer is preferably from 0.01 μm to 10 μm, particularly preferably from 0.05 μm to 5 μm.

As to the light transmittance and the polarizing degree of the thus-obtained polarizing plate, the higher, the more preferred. The transmittance of the polarizing plate for a light of 550 nm in wavelength is in the range of preferably from 30% to 50%, more preferably from 35% to 50%, most preferably from 40% to 50%. The polarizing degree for a light of 550 nm in wavelength is in the range of preferably from 90% to 100%, more preferably from 95% to 100%, most preferably from 99% to 100%.

Further, the thus-obtained polarizing plate can be laminated to a λ/4 plate to generate circularly polarized light. In this occasion, lamination is conducted so that the angle between the slow axis of the λ/4 plate and the absorption axis of the polarizing plate becomes 45°. The λ/4 plate is not particularly limited, but preferably has such wavelength dependence that retardation becomes smaller as the wavelength becomes shorter. Further, it is preferred to use a λ/4 plate comprising a polarizing film having an absorption axis inclined with an angle of from 20° to 70° with respect to the longitudinal direction and an optical anisotropic layer comprising a liquid crystalline compound.

### (B) Providing Optical Compensation Layer (Preparation of Optical Compensation Sheet)

The optical anisotropic layer is a layer for compensating a liquid crystal compound in a liquid crystal cell provided in a liquid crystal display device in displaying black, and can be formed by forming an orientation film on the cellulose acylate film and, further, by adding an optical compensatory layer on the orientation film.

### (B-1) Orientation Film

An orientation film is provided on the surface-treated cellulose acylate film. The orientation film has a function of deciding the orientation direction of liquid crystalline molecules. However, when the oriented state of the liquid crystalline compound is fixed after orientation of the compound, the orientation film is not essential as a constituent element of the present invention because its function has been fulfilled. That is, it is possible to transfer only the optical anisotropic layer having a fixed orientation state on the orientation film onto a polarizer to thereby prepare a polarizing plate of the present invention. The orientation film can be provided by, for example, rubbing treatment of an organic compound (preferably a polymer), oblique vacuum deposition of an inorganic compound, formation of a layer having microgrooves or accumulation of an organic compound (e.g., ω-tricosanoic acid, dioctadecylmethylammonium chloride or methyl stearate) by Langmuir-Blodgett method (LB membrane). Further, there are known orientation films which generate their orienting function when magnetic or electric field is applied thereto or when they are irradiated with light.

The orientation film is formed preferably by rubbing treatment of a polymer. The polymer to be used for the orientation film has, in principle, a molecular structure capable of orienting liquid crystal molecules.

In the present invention, in addition to the function of orienting liquid crystal molecules, it is preferred to bind a side chain having a cross-linkable functional group (e.g., double bond) to the main chain or to introduce a cross-linkable functional group having a function of orienting liquid crystalline molecules to the side chain of the polymer.

As the polymer to be used for the orientation film, either of a polymer which itself can cause cross-linking and a polymer which can be cross-linked with a cross-linking agent can be used. It is also possible to employ a plurality of combinations thereof. Examples of the polymer include methacrylate copolymers, styrenic copolymers, polyolefins, polyvinyl alcohol and modified polyvinyl alcohols, poly(N-methylolacrylamide), polyesters, polyimides, vinyl acetate-based copolymers, carboxymethyl cellulose and polycarbonates described in, for example, Japanese Patent Application Laid-Open No. 8-338913, paragraph [0022]. It is also possible to use a silane coupling agent as the polymer. As the polymer to be used for the orientation film, water-soluble polymers (e.g., poly(N-methylolacrylamide), carboxymethyl cellulose, gelatin, polyvinyl alcohol and modified polyvinyl alcohols) are preferred, and gelatin, polyvinyl alcohol and modified polyvinyl alcohols are more preferred. Polyvinyl alcohol and modified polyvinyl alcohols are most preferred. Particularly preferred is combination use of two kinds of polyvinyl alcohols or modified polyvinyl alcohols having different polymerization degree from each other. The saponification degree of the polyvinyl alcohol is preferably from 70% to 100%, more preferably from 80% to 100%. The polymerization degree of the polyvinyl alcohol is preferably from 100 to 5,000.

The side chain having the function of orienting liquid crystal molecules generally has a hydrophobic group as a functional group. Specific kind of the functional group is determined depending upon kind of the liquid crystal molecule and necessary orientation state. For example, a modifying group for the modified polyvinyl alcohols can be introduced by modification by copolymerization, modification by chain transfer or modification by block polymerization. Examples of the modifying group include a hydrophilic group (e.g., a carboxylic acid group, a sulfonic acid group, a phosphonic acid group, an amino group, an ammonium group, an amido group or a thiol group), a hydrocarbon group having from 10 to 100 carbon atoms, a fluorine atom-substituted hydrocarbon group, a thioether group, a polymerizable group (e.g., an unsaturated polymerizable group, an epoxy group or an aziridinyl group) and an alkoxysilyl group (e.g., trialkoxy, dialkoxy or monoalkoxy). Specific examples of these modified polyvinyl alcohols compounds include those described in, for example, Japanese Patent Application Laid-Open No. 2000-155216, paragraphs [0022] to [0145], and Japanese Patent Application Laid-Open No. 2002-62426, paragraphs [0018] to [0022].

The polymer of the orientation film and the multi-functional monomer contained in the optical anisotropic layer can be copolymerized with each other by allowing the side chain having cross-linkable functional group to bind to the main chain of the orientation film polymer or by introducing a cross-linkable functional group into the side chain having the function of orienting liquid crystal molecules. As a result, strong covalent bonding are formed between the orientation film polymer and the orientation film polymer and between the multi-functional monomer and the orientation film polymer as well as between the multi-functional monomer and the multi-functional monomer. Thus, strength of the optical compensatory sheet can remarkably be improved by introducing the cross-linkable functional group into the orientation film polymer.

The cross-linkable functional group of the orientation film polymer preferably contains a polymerizable group as is the same with the multi-functional monomer. Specific examples thereof include those described in, for example, Japanese Patent Application Laid-Open No. 2000-155216, paragraphs [0080] to [0100]. The orientation film polymer can be cross-linked using a cross-linking agent besides the above-mentioned cross-linkable functional group.

Examples of the cross-linking agents include aldehydes, N-methylol compounds, dioxane derivatives, compounds capable of functioning as a cross-linking agent by activating a carboxyl group, active vinyl compounds, active halogen-containing compounds, isoxazoles and dialdehyde starch. Two or more of the cross-linking agents may be used in combination thereof. Specific examples thereof include those compounds which are described in, for example, Japanese Patent Application Laid-Open No. 2002-62426, paragraphs [0023] to [0024]. Highly reactive aldehydes, particularly glutaraldehyde, are preferred.

The addition amount of the cross-linking agent is preferably from 0.1 to 20% by mass, more preferably from 0.5 to 15% by mass, based on the polymer. The amount of unreacted cross-linking agent remaining in the orientation film after cross-linking is preferably equal to or less than 1.0% by mass, more preferably equal to or less than 0.5% by mass. Such amounts ensure sufficient durability of not causing reticulation even when the orientation film is used for a long time in a liquid crystal display device or left for a long period in an atmosphere of high temperature and high humidity.

The orientation film can be formed basically by coating on a transparent supporting body a coating solution containing the aforesaid polymer which is a material for forming the orientation film and a cross-linking agent, drying under heating (to cross-link), then subjecting to rubbing treatment. As has been described hereinbefore, the cross-linking reaction may be conducted at any stage after coating of the coating solution on the transparent supporting body. In the case of using a water-soluble polymer such as polyvinyl alcohol as the orientation film-forming material, the coating solution is preferably prepared by using as a solvent a mixture of an organic solvent (e.g., methanol) having an anti-foaming function and water. The mixing ratio of water:methanol is preferably 0:100 to 99:1, more preferably from 0:100 to 91:9. Thus, generating of foam is prevented, and defects of the orientation film and, further, defects of the surface of the optical anisotropic layer can remarkably be reduced.

As a coating method for the orientation film, a spin coating method, a dip coating method, a curtain coating method, an extrusion coating method, a rod coating method or a roll coating method is preferred, with rod coating method being particularly preferred. The dry thickness of the orientation film is preferably from 0.1 to 10 μm. The drying under heating can be conducted at a temperature of from 20° C. to 110° C. In order to form sufficient cross-linking, the temperature is preferably from 60° C. to 100° C., more preferably from 80° C. to 100° C. The drying period can be from 1 min to 36 hours, and is preferably from 1 minute to 30 minute. The pH is preferably set to a level optimal for a cross-linking agent to be used. In the case of using glutaraldehyde, the pH is from 4.5 to 5.5, and it is preferably from 5.0.

The orientation film is provided on the transparent supporting body or the aforesaid undercoat layer. The orientation film can be obtained by cross-linking the polymer layer as described above, then subjecting the surface thereof to rubbing treatment.

As the rubbing treatment, a treating method widely employed as a method for orienting liquid crystal of LCD can be applied. That is, there may be employed a method of orienting by rubbing the surface of the orientation film in a definite direction by using paper, gauge, felt, rubber, nylon fibers or polyester fibers. In general, rubbing treatment is conducted by rubbing several times using cloth uniformly implanted with fibers having a uniform length and thickness.

In the case of conducting on an industrial scale, the rubbing treatment can be conducted by bringing a film having the polarizing layer, while conveying the film, into contact with a rotating rubbing roll. The roundness, cylinder degree and deflection (eccentricity) of the rubbing roll are all preferably 30 μm or less. The lapping angle of the film with respect to the rubbing roll is preferably from 0.1° to 90°. However, as is described in Japanese Patent Application Laid-Open No. 8-160430, it is also possible to perform stable rubbing treatment by winding 360° or more. The film-conveying rate is preferably from 1 m/min to 100 m/min. As to the rubbing angle, a proper rubbing angle is preferably selected in the range of from 0° to 60°. In the case of using for a liquid crystal display device, the angle is preferably from 40° to 50°, with 45° being particularly preferred.

The thickness of the thus-obtained orientation film is preferably in the range of from 0.1 μm to 10 μm.

Next, the liquid crystalline molecules of the optical anisotropic layer are oriented on the orientation film. Then, as needed, the orientation film polymer is cross-linked by reacting the orientation film polymer with the multi-functional monomer contained in the optical anisotropic layer or by using the cross-linking agent.

The liquid crystalline molecules used in the optical anisotropic layer include rod-like liquid crystalline molecules and discotic liquid crystalline molecules. The rod-like liquid crystalline molecules and discotic liquid crystalline molecules may be high molecular liquid crystals or low molecular liquid crystals. Further, they included those where low molecular liquid crystal molecules have been cross-linked thereby to lose liquid crystal properties.

### (B-2) Rod-Like Liquid Crystalline Molecules

Examples of rod-shaped liquid crystalline molecules preferably used include: azomethines, azoxys, cyanobiphenyls, cyanophenyl esters, benzoate esters, cyclohexane carboxylic acid phenyl esters, cyanophenyl cyclohexanes, cyano-substituted phenyl pyrimidines, alkoxy-substituted phenyl pyrimidines, phenyl dioxanes, tolans, and alkenyl cyclohexyl benzonitriles.

Rod-shaped liquid crystalline molecules also include metal complexes. Liquid crystal polymer that includes rod-shaped liquid crystalline molecules in its repeating unit can also be used as rod-shaped liquid crystalline molecules. In other words, rod-shaped liquid crystalline molecules may be bonded to (liquid crystal) polymer.

Rod-shaped liquid crystalline molecules are described in Kikan Kagaku Sosetsu (Survey of Chemistry, Quarterly), Vol. 22, Chemistry of Liquid Crystal (1994), edited by The Chemical Society of Japan, Chapters 4, 7 and 11 and in Handbook of Liquid Crystal Devices, edited by 142th Committee of Japan Society for the Promotion of Science, Chapter 3.

The index of birefringence of the rod-shaped liquid crystalline molecules is preferably in the range of 0.001 to 0.7. To allow the oriented state to be fixed, preferably the rod-shaped liquid crystalline molecules have a polymerizable group. As such a polymerizable group, a radically polymerizable unsaturated group or cationically polymerizable group is preferable. Specific examples of such polymerizable groups include: polymerizable groups and polymerizable liquid crystal compounds described in Japanese Patent Application Laid-Open No. 2002-62427, columns [0064] to [0086].

### (B-3) Discotic Liquid Crystalline Molecules

Discotic liquid crystalline molecules include: benzene derivatives described in the research report by C. Destrade et al., Mol. Cryst. Vol. 71, 111 (1981); truxene derivatives described in the research report by C. Destrade et al., Mol. Cryst. Vol. 122, 141 (1985) and Physics lett, A, Vol. 78, 82 (1990); cyclohexane derivatives described in the research report by B. Kohne et al., Angew. Chem. Vol. 96, 70 (1984); and azacrown or phenylacetylene macrocycles described in the research report by J. M. Lehn et al., J. Chem. Commun., 1794 (1985) and in the research report by J. Zhang et al., L. Am. Chem. Soc. Vol. 116, 2655 (1994).

Discotic liquid crystalline molecules also include liquid crystalline compounds having a structure in which straight-chain alkyl group, alkoxy group and substituted benzoyloxy group are substituted radially as the side chains of the mother nucleus at the center of the molecules. Preferably, the compounds are such that their molecules or groups of molecules have rotational symmetry and they can provide an optically anisotropic layer with a fixed orientation. In the ultimate state of the optically anisotropic layer formed of discotic liquid crystalline molecules, the compounds contained in the optically anisotropic layer are not necessarily discotic liquid crystalline molecules. The ultimate state of the optically anisotropic layer also contain compounds such that they are originally of low-molecular-weight discotic liquid crystalline molecules having a group reactive with heat or light, but undergo polymerization or crosslinking by heat or light, thereby becoming higher-molecular-weight molecules and losing their liquid crystallinity. Examples of preferred discotic liquid crystalline molecules are described in Japanese Patent Application Laid-Open No. 8-50206. And the details of the polymerization of discotic liquid crystalline molecules are described in Japanese Patent Application Laid-Open No. 8-27284.

To fix the discotic liquid crystalline molecules by polymerization, it is necessary to bond a polymerizable group, as a substitute, to the discotic core of the discotic liquid crystalline molecules. Compounds in which their discotic core and a polymerizable group are bonded to each other via a linking group are preferably used. With such compounds, the oriented state is maintained during the polymerization reaction. Examples of such compounds include: those described in Japanese Patent Application Laid-Open No. 2000-155216, columns [0151] to [0168].

In hybrid orientation, the angle between the long axis (disc plane) of the discotic liquid crystalline molecules and the plane of the polarizing film increases or decreases, across the depth of the optically anisotropic layer, with increase in the distance from the plane of the polarizing film. Preferably, the angle decreases with increase in the distance. The possible changes in angle include: continuous increase, continuous decrease, intermittent increase, intermittent decrease, change including both continuous increase and continuous decrease, and intermittent change including increase and decrease. The intermittent changes include the area midway across the thickness where the tilt angle does not change. Even if the change includes the area where the angle does not change, it does not matter as long as the angle increases or decreased as a whole. Preferably, the angle changes continuously.

Generally, the average direction of the long axis of the discotic liquid crystalline molecules on the polarizing film side can be adjusted by selecting the type of discotic liquid crystalline molecules or the material for the orientation film, or by selecting the method of rubbing treatment. On the other hand, generally the direction of the long axis (disc plane) of the discotic liquid crystalline molecules on the surface side (on the air side) can be adjusted by selecting the type of discotic liquid crystalline molecules or the type of the additives used together with the discotic liquid crystalline molecules. Examples of additives used with the discotic liquid crystalline molecules include: plasticizer, surfactant, polymerizable monomer, and polymer. The degree of the change in orientation in the long axis direction can also be adjusted by selecting the type of the liquid crystalline molecules and that of additives, like the above described cases.

### (B-4) Other Constituents of the Optical Compensatory Layer

Use of plasticizer, surfactant, polymerizable monomer, etc. together with the above described liquid crystalline molecules makes it possible to improve the uniformity of the coating film, the strength of the film and the orientation of liquid crystalline molecules. Preferably, such additives are compatible with the liquid crystalline molecules, and they can change the tilt angle of the liquid crystalline molecules or do not inhibit the orientation of the liquid crystalline molecules.

Examples of polymerizable monomers applicable include radically polymerizable or cationically polymerizable compounds. Preferable are radically polymerizable polyfunctional monomers which are copolymerizable with the above described polymerizable-group containing liquid crystalline compounds. Specific examples are those described in Japanese Patent Application Laid-Open No. 2002-296423, columns [0018] to [0020]. The amount of the above described compounds added is generally in the range of 1 to 50% by mass of the discotic liquid crystalline molecules and preferably in the range of 5 to 30% by mass.

Examples of surfactants include traditionally known compounds; however, fluorine compounds are particularly preferable. Specific examples of fluorine compounds include compounds described in Japanese Patent Application Laid-Open No. 2001-330725, columns [0028] to [0056].

Preferably, polymers used together with the discotic liquid crystalline molecules can change the tilt angle of the discotic liquid crystalline molecules.

Examples of polymers applicable include cellulose esters. Examples of preferred cellulose esters include those described in Japanese Patent Application Laid-Open No. 2000-155216, columns [0178]. Not to inhibit the orientation of the liquid crystalline molecules, the amount of the above described polymers added is preferably in the range of 0.1 to 10% by mass of the liquid crystalline molecules and more preferably in the range of 0.1 to 8% by mass.

The discotic nematic liquid crystal phase—solid phase transition temperature of the discotic liquid crystalline molecules is preferably 70 to 300° C. and more preferably 70 to 170° C.

### (B-5) Formation of the Optical Anisotropic Layer

An optically anisotropic layer can be formed by coating the surface of the orientation film with a coating fluid that contains liquid crystalline molecules and, if necessary, polymerization initiator or any other ingredients described later.

As a solvent used for preparing the coating fluid, an organic solvent is preferably used. Examples of organic solvents applicable include: amides (e.g. N,N-dimethylformamide); sulfoxides (e.g. dimethylsulfoxide); heterocycle compounds (e.g. pyridine); hydrocarbons (e.g. benzene, hexane); alkyl halides (e.g. chloroform, dichloromethane, tetrachloroethane); esters (e.g. methyl acetate, butyl acetate); ketones (e.g. acetone, methyl ethyl ketone); and ethers (e.g. tetrahydrofuran, 1,2-dimethoxyethane). Alkyl halides and ketones are preferably used. Two or more kinds of organic solvent can be used in combination.

Such a coating fluid can be applied by a known method (e.g. wire bar coating, extrusion coating, direct gravure coating, reverse gravure coating or die coating method).

The thickness of the optically anisotropic layer is preferably 0.1 to 20 μm, more preferably 0.5 to 15 μm, and most preferably 1 to 10 μm.

### (B-6) Fixation of Orientation State of Liquid Crystalline Molecules

The oriented state of the oriented liquid crystalline molecules can be maintained and fixed. Preferably, the fixation is performed by polymerization. Types of polymerization include: heat polymerization using a heat polymerization initiator and photopolymerization using a photopolymerization initiator. For the fixation, photopolymerization is preferably used.

Examples of photopolymerization initiators include: α-carbonyl compounds (described in U.S. Pat. Nos. 2,367,661 and 2,367,670); acyloin ethers (described in U.S. Pat. No. 2,448,828); α-hydrocarbon-substituted aromatic acyloin compounds (U.S. Pat. No. 2,722,512); multi-nucleus quinone compounds (described in U.S. Pat. Nos. 3,046,127 and 2,951,758); combinations of triarylimidazole dimmer and p-aminophenyl ketone (described in U.S. Pat. No. 3,549,367); acridine and phenazine compounds (described in Japanese Patent Application Laid-Open No. 60-105667 and U.S. Pat. No. 4,239,850); and oxadiazole compounds (described in U.S. Pat. No. 4,212,970).

The amount of the photopolymerization initiators used is preferably in the range of 0.01 to 20% by mass of the solid content of the coating fluid and more preferably in the range of 0.5 to 5% by mass.

Light irradiation for the polymerization of liquid crystalline molecules is preferably performed using ultraviolet light.

Irradiation energy is preferably in the range of 20 mJ/cm² to 50 J/cm², more preferably 20 to 5000 mJ/cm², and much more preferably 100 to 800 mJ/cm². To accelerate the photopolymerization, light irradiation may be performed under heat.

A protective layer may be provided on the surface of the optically anisotropic layer. Combining the optical compensation film with a polarizing layer is also preferable. Specifically, an optically anisotropic layer is formed on a polarizing film by coating the surface of the polarizing film with the above described coating fluid for an optically anisotropic layer. As a result, thin polarlizer, in which stress generated with the dimensional change of polarizing film (distorsion×cross-sectional area×modulus of elasticity) is small, can be prepared without using a polymer film between the polarizing film and the optically anisotropic layer. Installing the polarizer according to the present invention in a large-sized liquid crystal display device enables high-quality images to be displayed without causing problems such as light leakage.

Preferably, stretching is performed while keeping the tilt angle of the polarizing layer and the optical compensation layer to the angle between the transmission axis of the two sheets of polarizer laminated on both sides of a liquid crystal cell constituting LCD and the longitudinal or transverse direction of the liquid crystal cell. Generally the tilt angle is 45°. However, in recent years, transmissive-, reflective-, and semi-transmissive-liquid crystal display devices have been developed in which the tilt angle is not always 45°, and thus, it is preferable to adjust the stretching direction arbitrarily to the design of each LCD.

### (B-7) Liquid Crystal Display Device

Liquid crystal modes in which the above described optical compensation film is used will be described.

### (TN-Mode Liquid Crystal Display Device)

TN-mode liquid crystal display devices are most commonly used as a color TFT liquid crystal display device and described in a large number of documents. The oriented state in a TN-mode liquid crystal cell in the black state is such that the rod-shaped liquid crystalline molecules stand in the middle of the cell while the rod-shaped liquid crystalline molecules lie near the substrates of the cell.

### (OCB-Mode Liquid Crystal Display Device)

An OCB-mode liquid crystal cell is a bend orientation mode liquid crystal cell where the rod-shaped liquid crystalline molecules in the upper part of the liquid cell and those in the lower part of the liquid cell are oriented in substantially opposite directions (symmetrically). Liquid crystal displays using a bend orientation mode liquid crystal cell are disclosed in U.S. Pat. Nos. 4,583,825 and 5,410,422. A bend orientation mode liquid crystal cell has a self-compensation function since the rod-shaped liquid crystalline molecules in the upper part of the liquid cell and those in the lower part are symmetrically oriented. Thus, this liquid crystal mode is also referred to as OCB (Optically Compensatory Bend) liquid crystal mode.

Like in the TN-mode cell, the oriented state in an OCB-mode liquid crystal cell in the black state is also such that the rod-shaped liquid crystalline molecules stand in the middle of the cell while the rod-shaped liquid crystalline molecules lie near the substrates of the cell.

### (VA-Mode Liquid Crystal Display Device)

VA-mode liquid crystal cells are characterized in that in the cells, rod-shaped liquid crystalline molecules are oriented substantially vertically when no voltage is applied. The VA-mode liquid crystal cells include: (1) a VA-mode liquid crystal cell in a narrow sense where rod-shaped liquid crystalline molecules are oriented substantially vertically when no voltage is applied, while they are oriented substantially horizontally when a voltage is applied (Japanese Patent Application Laid-Open No. 2-176625); (2) a MVA-mode liquid crystal cell obtained by introducing multi-domain switching of liquid crystal into a VA-mode liquid crystal cell to obtain wider viewing angle, (SID 97, Digest of Tech. Papers (Proceedings) 28 (1997) 845), (3) a n-ASM-mode liquid crystal cell where rod-shaped liquid crystalline molecules undergo substantially vertical orientation when no voltage is applied, while they undergo twisted multi-domain orientation when a voltage is applied (Proceedings 58 to 59 (1998), Symposium, Japanese Liquid Crystal Society); and (4) a SURVAIVAL-mode liquid crystal cell (reported in LCD international 98).

### (IPS-Mode Liquid Crystal Display Device)

IPS-mode liquid crystal cells are characterized in that in the cells, rod-shaped liquid crystalline molecules are oriented substantially horizontally in plane when no voltage is applied and switching is performed by changing the orientation direction of the crystal in accordance with the presence or absence of application of voltage. Specific examples of IPS-mode liquid crystal cells applicable include those described in Japanese Patent Application Laid-Open Nos. 2004-365941, 2004-12731, 2004-215620, 2002-221726, 2002-55341 and 2003-195333.

### (Other Liquid Crystal Display Devices)

ECB-mode and STN-mode liquid crystal display devices can also be optically compensated based on the same concept as described above.

### (C) Providing Antireflection Layer (Antireflection Film)

Generally an antireflection film is made up of: a low-refractive-index layer which also functions as a stainproof layer; and at least one layer having a refractive index higher than that of the low-refractive-index layer (i.e. high-refractive-index layer and/or intermediate-refractive-index layer) provided on a transparent substrate.

Methods of forming a multi-layer thin film as a laminate of transparent thin films of inorganic compounds (e.g. metal oxides) having different refractive indices include: chemical vapor deposition (CVD); physical vapor deposition (PVD); and a method in which a film of a colloid of metal oxide particles is formed by sol-gel process from a metal compound such as a metal alkoxide and the formed film is subjected to post-treatment (ultraviolet light irradiation: Japanese Patent Application Laid-Open No. 9-157855, plasma treatment: Japanese Patent Application Laid-Open No. 2002-327310).

On the other hand, there are proposed a various antireflection films, as highly productive antireflection films, which are formed by coating thin films of a matrix and inorganic particles dispersing therein in a laminated manner.

There is also provided an antireflection film including an antireflection layer provided with anti-glare properties, which is formed by using an antireflection film formed by coating as described above and providing the outermost surface of the film with fine irregularities.

The cellulose acylate film of the present invention is applicable to antireflection films formed by any of the above described methods, but particularly preferable is the antireflection film formed by coating (coating type antireflection film).

### (C-1) Layer Configuration of Coating-Type Antireflection Film

An antireflection film having at least on its substrate a layer construction of: intermediate-refractive-index layer, high-refractive-index layer and low-refractive-index layer (outermost layer) in this order is designed to have a refractive index satisfying the following relationship.

Refractive index of high-refractive-index layer>refractive index of intermediate-refractive-index layer>refractive index of transparent substrate>refractive index of low-refractive-index layer, and a hard coat layer may be provided between the transparent substrate and the intermediate-refractive-index layer.

The antireflection film may also be made up of: intermediate-refractive-index hard coat layer, high-refractive-index layer and low-refractive-index layer.

Examples of such antireflection films include: those described in Japanese Patent Application Laid-Open Nos. 8-122504, 8-110401, 10-300902, 2002-243906 and 2000-111706. Other functions may also be imparted to each layer. There are proposed, for example, antireflection films that include a stainproofing low-refractive-index layer or anti-static high-refractive-index layer (e.g. Japanese Patent Application Laid-Open Nos. 10-206603 and 2002-243906).

The haze of the antireflection film is preferably 5% or less and more preferably 3% or less. The strength of the film is preferably H or higher, by pencil hardness test in accordance with JIS K5400, more preferably 2H or higher, and most preferably 3H or higher.

### (C-2) High-Refractive-Index Layer and Intermediate-Refractive-Index Layer

The layer of the antireflection film having a high refractive index consists of a curable film that contains: at least ultra-fine particles of high-refractive-index inorganic compound having an average particle size of 100 nm or less; and a matrix binder.

Fine particles of high-refractive-index inorganic compound include: for example, those of inorganic compounds having a refractive index of 1.65 or more and preferably 1.9 or more. Specific examples of such inorganic compounds include: oxides of Ti, Zn, Sb, Sn, Zr, Ce, Ta, La or In; and composite oxides containing these metal atoms.

Methods of forming such ultra-fine particles include: for example, treating the particle surface with a surface treatment agent (e.g. a silane coupling agent, Japanese Patent Application Laid-Open Nos. 11-295503, 11-153703, 2000-9908, an anionic compound or organic metal coupling agent, Japanese Patent Application Laid-Open No. 2001-310432 etc.); allowing particles to have a core-shell structure in which a core is made up of high-refractive-index particle(s) (Japanese Patent Application Laid-Open No. 2001-166104 etc.); and using a specific dispersant together (Japanese Patent Application Laid-Open No. 11-153703, U.S. Pat. No. 6,210,858B1, Japanese Patent Application Laid-Open No. 2002-2776069, etc.).

Materials used for forming a matrix include: for example, conventionally known thermoplastic resins and curable resin films.

Further, as such a material, at least one composition is preferable which is selected from the group consisting of: a composition including a polyfunctional compound that has at least two radically polymerizable and/or cationically polymerizable group; an organic metal compound containing a hydrolytic group; and a composition as a partially condensed product of the above organic metal compound. Examples of such materials include: compounds described in Japanese Patent Application Laid-Open Nos. 2000-47004, 2001-315242, 2001-31871 and 2001-296401.

A curable film prepared using a colloidal metal oxide obtained from the hydrolyzed condensate of metal alkoxide and a metal alkoxide composition is also preferred. Examples are described in Japanese Patent Application Laid-Open No. 2001-293818.

The refractive index of the high-refractive-index layer is generally 1.70 to 2.20. The thickness of the high-refractive-index layer is preferably 5 nm to 10 μm and more preferably 10 nm to 1 μm.

The refractive index of the intermediate-refractive-index layer is adjusted to a value between the refractive index of the low-refractive-index layer and that of the high-refractive-index layer. The refractive index of the intermediate-refractive-index layer is preferably 1.50 to 1.70.

### (C-3) Low-Refractive-Index Layer

The low-refractive-index layer is formed on the high-refractive-index layer sequentially in the laminated manner. The refractive index of the low-refractive-index layer is 1.20 to 1.55 and preferably 1.30 to 1.50.

Preferably, the low-refractive-index layer is formed as the outermost layer having scratch resistance and stainproofing properties. As means of significantly improving scratch resistance, it is effective to provide the surface of the layer with slip properties, and conventionally known thin film forming means that includes introducing silicone or fluorine is used.

The refractive index of the fluorine-containing compound is preferably 1.35 to 1.50 and more preferably 1.36 to 1.47. The fluorine-containing compound is preferably a compound that includes a crosslinkable or polymerizable functional group containing fluorine atom in an amount of 35 to 80% by mass.

Examples of such compounds include: compounds described in Japanese Patent Application Laid-Open No. 9-222503, columns [0018] to [0026], Japanese Patent Application Laid-Open No. 11-38202, columns [0019] to [0030], Japanese Patent Application Laid-Open No. 2001-40284, columns [0027] to [0028], Japanese Patent Application Laid-Open No. 2000-284102, etc.

A silicone compound is preferably such that it has a polysiloxane structure, it includes a curable or polymerizable functional group in its polymer chain, and it has a crosslinking structure in the film. Examples of such silicone compounds include: reactive silicone (e.g. SILAPLANE manufactured by Chisso Corporation); and polysiloxane having a silanol group on each of its ends (one described in Japanese Patent Application Laid-Open No. 11-258403).

The crosslinking or polymerization reaction for preparing such fluorine-containing polymer and/or siloxane polymer containing a crosslinkable or polymerizable group is preferably carried out by radiation of light or by heating simultaneously with or after applying a coating composition for forming an outermost layer, which contains a polymerization initiator, a sensitizing agent, etc.

A sol-gel cured film is also preferable which is obtained by curing the above coating composition by the condensation reaction carried out between an organic metal compound, such as silane coupling agent, and silane coupling agent containing a specific fluorine-containing hydrocarbon group in the presence of a catalyst.

Examples of such films include: those of polyfluoroalkyl-group-containing silane compounds or the partially hydrolyzed and condensed compounds thereof (compounds described in Japanese Patent Application Laid-Open Nos. 58-142958, 58-147483, 58-147484, 9-157582 and 11-106704); and silyl compounds that contain “perfluoroalkyl ether” group as a fluoline-containing long-chain group (compounds described in Japanese Patent Application Laid-Open Nos. 2000-117902, 2001-48590 and 2002-53804).

The low-refractive-index layer can contain additives other than the above described ones, such as filler (e.g. low-refractive-index inorganic compounds whose primary particles have an average particle size of 1 to 150 nm, such as silicon dioxide (silica) and fluorine-containing particles (magnesium fluoride, calcium fluoride, barium fluoride); organic fine particles described in Japanese Patent Application Laid-Open No. 11-3820, columns [0020] to [0038]), silane coupling agent, slippering agent and surfactant.

When located under the outermost layer, the low-refractive-index layer may be formed by vapor phase method (vacuum evaporation, spattering, ion plating, plasma CVD, etc.). From the viewpoint of reducing producing costs, coating method is preferable. The thickness of the low-refractive-index layer is preferably 30 to 200 nm, more preferably 50 to 150 nm, and most preferably 60 to 120 nm.

### (C-4) Hard Coat Layer

The hard coat layer is provided on the surface of the transparent supporting body in order to impart a sufficient physical strength to the anti-reflective film. It is particularly preferred to provide the hard coat layer between the transparent supporting body and the high refractive index layer.

Preferably, the hard coat layer is formed by the crosslinking reaction or polymerization of compounds curable by light and/or heat. Preferred curable functional groups are photopolymerizable functional groups, and organic metal compounds having a hydrolytic functional group are preferably organic alkoxy silyl compounds.

Specific examples of such compounds include the same compounds as illustrated in the description of the high-refractive-index layer.

Specific examples of compositions that constitute the hard coat layer include: those described in Japanese Patent Application Laid-Open Nos. 2002-144913, 2000-9908 and WO 0/46617.

The high-refractive-index layer can also serve as a hard coat layer. In this case, it is preferable to form the hard coat layer using the technique described in the description of the high-refractive-index layer so that fine particles are contained in the hard coat layer in the dispersed state.

The hard coat layer can also serves as an anti-glare layer (described later), if particles having an average particle size of 0.2 to 10 μm are added to provide the layer with the anti-glare function.

The thickness of the hard coat layer can be properly designed depending on the applications for which it is used. The thickness of the hard coat layer is preferably 0.2 to 10 μm and more preferably 0.5 to 7 μm.

The strength of the hard coat layer is preferably H or higher, by pencil hardness test in accordance with JIS K5400, more preferably 2H or higher, and much more preferably 3H or higher. The hard coat layer having a smaller abrasion loss in test, before and after Taber abrasion test conducted in accordance with JIS K5400, is more preferable.

### (C-5) Forward Scattering Layer

A forward scattering layer is provided so that it provides, when applied to liquid crystal displays, the effect of improving viewing angle when the angle of vision is tilted up-, down-, right- or leftward. The above described hard coat layer can also serve as a forward scattering layer, if fine particles with different refractive index are dispersed in it.

Example of such layers include: those described in Japanese Patent Application Laid-Open No. 11-38208 where the coefficient of forward scattering is specified; those described in Japanese Patent Application Laid-Open No. 2000-199809 where the relative refractive index of transparent resin and fine particles are allowed to fall in the specified range; and those described in Japanese Patent Application Laid-Open No. 2002-107512 wherein the haze value is specified to 40% or higher.

### (C-6) Other Layers

Besides the above described layers, a primer layer, anti-static layer, undercoat layer or protective layer may be provided.

### (C-7) Coating Method

The layers of the antireflection film can be formed by any method of dip coating, air knife coating, curtain coating, roller coating, wire bar coating, gravure coating, microgravure coating and extrusion coating (U.S. Pat. No. 2,681,294).

### (C-8) Anti-Glare Function

The antireflection film may have the anti-glare function that scatters external light. The anti-glare function can be obtained by forming irregularities on the surface of the antireflection film. When the antireflection film has the anti-glare function, the haze of the antireflection film is preferably 3 to 30%, more preferably 5 to 20%, and most preferably 7 to 20%.

As a method for forming irregularities on the surface of antireflection film, any method can be employed, as long as it can maintain the surface geometry of the film. Such methods include: for example, a method in which fine particles are used in the low-refractive-index layer to form irregularities on the surface of the film (e.g. Japanese Patent Application Laid-Open No. 2000-271878); a method in which a small amount (0.1 to 50% by mass) of particles having a relatively large size (0.05 to 2 μm in particle size) are added to the layer under a low-refractive-index layer (high-refractive-index layer, intermediate-refractive-index layer or hard coat layer) to form a film having irregularities on the surface and a low-refractive-index layer is formed on the irregular surface while keeping the geometry (e.g. Japanese Patent Application Laid-Open Nos. 2000-281410, 2000-95893, 2001-100004, 2001-281407); a method in which irregularities are physically transferred on the surface of the outermost layer (stainproofing layer) having been provided (e.g. embossing described in Japanese Patent Application Laid-Open Nos. 63-278839, 11-183710, 2000-275401).

Hereafter, the measurement methods used for the present invention are described.

### [1] Re and Rth Measurement Methods

A sample film was humidity-conditioned at 25° C. and 60% rh for 3 hours or more, and then retardation values of the sample were measured at a wavelength of 550 nm and at 25° C. and 60% rh for a direction perpendicular to the sample film surface and a direction tilted by ±40° from the film surface normal by using an automatic birefringence analyzer (KOBRA-21ADH/PR, produced by Oji Scientific Instruments). An in-plane retardation (Re) value was calculated from the measured value for the perpendicular direction and a thickness-direction retardation (Rth) value from the measured values for the perpendicular direction and the ±40° direction.

[2] Re, Rth, and Re and Rth variations in width and longitudinal directions

### (1) Sampling in MD Direction

100 pieces of samples each having a size of 1 cm² square are cut at intervals of 0.5 m along the longitudinal direction.

### (2) Sampling in TD Direction

50 pieces of samples each having a size of 1 cm² square are cut at equal intervals in the entire width direction of the formed film.

### (3) Re and Rth Measurement

A sample film was humidity-conditioned at 25° C. and 60% rh for 3 hours or more, and then retardation values of the sample were measured at a wavelength of 550 nm and at 25° C. and 60% rh for a direction perpendicular to the sample film surface and a direction tilted by ±40° from the normal of the film surface by using an automatic birefringence analyzer (KOBRA-21ADH/PR, produced by Oji Scientific Instruments). An in-plane retardation (Re) value was calculated from the measured value for the perpendicular direction and a thickness-direction retardation (Rth) value from the measured values for the perpendicular direction and the ±40° direction. Averages of the measured values for all of the sampling points were used as the Re value and Rth value.

### (4) Variation of Re Value and Rth Value

Difference between the maximum value and minimum value among the values obtained for 100 points for the MD direction or 50 points for the TD direction was divided with the average and represented in terms of percentage as variation of the Re value or Rth value.

### [3] Elongation at Break by Tensilon Stretching

Each sample was pre-heated for 1 minute in an oven heated to Tg+10° C. using a heating Tensilon manufactured by Toyo Seiki Seisaku-Sho, Ltd. and then stretched, while keeping the distance between chucks 100 mm and rate of pulling at 100 mm/min, until it broke so as to obtain its elongation at break.

### [4] Substitution Degree of Cellulose Acylate

Acyl substitution degree of the cellulose acylate was obtained by 13C-NMR according to the method described in Carbohydr. Res. 273 (1995) pp. 83-91 (Tezuka, et al.).

### [5] DSC Crystal Melting Peak Calorie

The calorie was measured at a temperature rising rate of 10° C./min using a DSC-50 (manufactured by Shimadzu Corporation), and a calorie at an endothermic peak appearing immediately after Tg was calculated in terms of J/g. At the same time, Tg was measured.

### [6] Haze

Using a turbidity meter NDH-1001DO (produced by Nippon Denshoku Industries Co., Ltd.), the haze of the sample was measured.

### [7] Yellowness Index (YI Value)

Using Z-II Optical Sensor, yellowness index (Y1) was measured in accordance with JIS K7105 6.3.

A reflection method was used for a pellet, and a transmission method was used to obtain tristimulus values X, Y, and Z for a film. Further, using the tristimulus values X, Y, and Z, a YI value was calculated by the following equation.

YI={(1.28X−1.06Z)/Y}×100

Further, the YI value of film obtained by the above equation was divided by the thickness of the film to be converted in terms of 1 mm for comparison.

### [8] Molecular Weight

A film sample was dissolved in dichloromethane and the molecular weight was measured using GPC.

### [9] Degree of Polymerization

About 0.2 g of absolutely dried cellulose acylate was weighed and dissolved in 100 ml of mixed solvent of methylene chloride:ethanol=9:1 (mass ratio). The time (second) of flow down of this solution at 25° C. was measured using an Ostwald viscometer and the degree of polymerization was obtained from the following equations:

ηrel=T/T0

[η]=(1nηrel)/C

DP=[η]/Km

wherein T: the time (second) it took the sample to flow down, T0: the time (second) it took the solvent alone to flow down, C: concentration (g/l), and Km: 6×10⁻⁴.

### [10] Measurement of Tg

20 mg of sample was put in a DSC pan. The sample was heated, in a stream of nitrogen, from 30° C. to 250° C. at heating rate of 10° C./min (1st-run) and then cooled to 30° C. at cooling rate of −10° C./min. Then the sample was again heated from 30° C. to 250° C. (2nd-run). The temperature at which the baseline begins to deviate from the low temperature side in the 2nd-run was taken as the glass transition temperature (Tg). 0.05% by mass of fine particles of silicon dioxide (Aerosil R972V) was added to each level of cellulose acylate.

### [11] Measurement of Dimensional Change

(1) Each sample film was cut into 25 cm×5 cm and subjected to moisture conditioning at 25° C. and 60% rh for 3 hours or longer, and the dimension was measured with a pin gage 20 cm length. The measurement was represented with X cm.

(2) The sample was then heat treated at 60° C. and 90% rh for 24 hours and subjected to moisture conditioning at 25° C. and 60% rh for 3 hours or longer, and the dimension was measured with a pin gage 20 cm length. The measurement was represented with Y cm.

(3) The value (Y−X)·100/X was taken as the percent of dimensional change (%).

### EXAMPLE

### Cellulose Acylate Resin

In the preparation of cellulose acylate, sulfuric acid (7.8 parts by weight per 100 parts by weight of cellulose) was added as a catalyst, and a carboxylic acid, as a raw material of acyl substituent, was added to perform acyllation at 40° C. The kind and substitution degree of acyl group were adjusted by adjusting the kind and amount of the carboxylic acid added. After acyllation, aging was performed at 40° C.

### [Melt Film Formation]

The cellulose acylate resin was formed into cylindrical pellets 3 mm in diameter and 5 mm in length. In this operation, a plasticizer was selected from among those described below and kneaded into the pellets. The pellets were dried in vacuum drier at 110° C. so that their moisture content was 0.1% or less, and after adjusting their temperature to Tg−10° C., they were fed to a hopper. The plasticizer was selected from among TPP: triphenylphosphate, BDP: biphenyldiphenyl phosphate, DOA: bis(2-ethylhexyl) adipate, and PTP: 1,4-phenylene-tetraphenyl phosphate ester.

The melting temperature was adjusted so that the melt viscosity was 1000 Pa·s and the pellets were melted in single-screw extruder set at 210° C., extruded from a T die, whose temperature was set at the same as that of the melting temperature, into a sheet upon a cooling drum set at Tg−5° C., where it was cooled and solidified to give a cellulose acylate film. At this operation, electrostatic application method was employed for each level of melt (a wire of 10 kV was positioned 10 cm apart from the point of the cooling drum where the melt was landed). The solidified sheet was stripped off from the cooling drum and wound up into a roll. The sheet of each level of cellulose acylate thus obtained was 1.5 m wide and wound up at a wind-up rate of 30 m/min to 3000 m long.

### [Stretching]

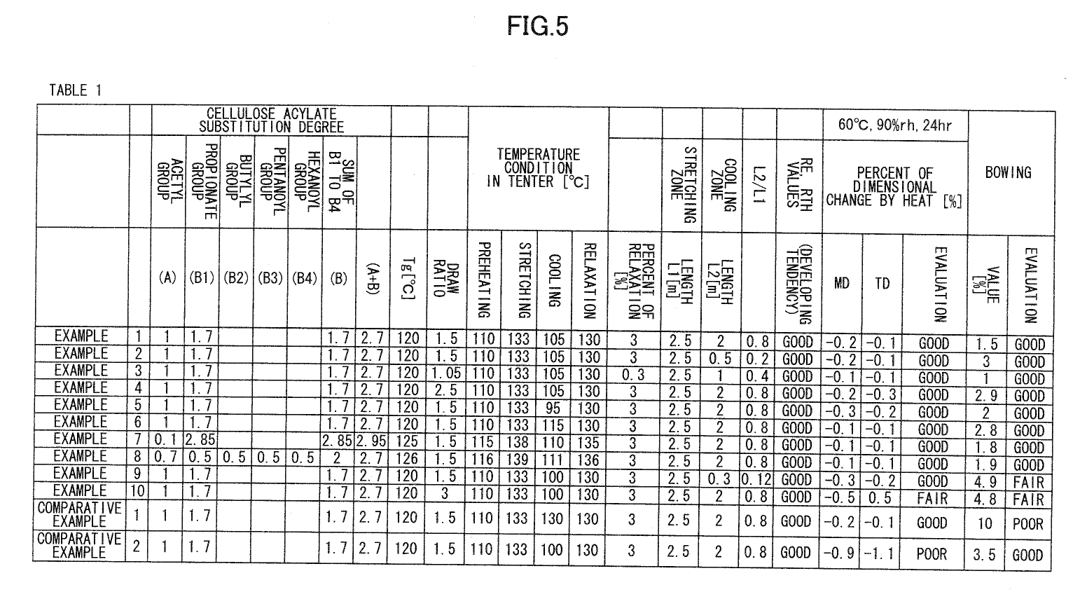

Each cellulose acylate film prepared by the melt film formation was stretched longitudinally at Tg+5° C. to give a 1.2 times length and stretched transversely at the draw ratio described in Table 1 (FIG. 5). The cellulose acylate film having undergone transverse stretching was cooled and subjected to thermal relaxation treatment. The conditions under which the stretching was performed, such as the temperatures of preheating, stretching, cooling or thermal relaxation treatment and the length of zones, are described in Table 1.

For each of the resultant stretched cellulose acylate films, the percent of dimensional change by heat and bowing were measured and evaluated. The percent of dimensional change by heat was obtained by keeping each cellulose acylate film at 60° C. and 90% rh for 24 hours. Films whose percent of dimensional change was ±0.5% or less were judged to be acceptable and films whose bowing was 5% or less were also judged to be acceptable. The results are shown in Table 1.

### <Quality Evaluation of Stretched Cellulose Acylate Film>

As is apparent from Table 1, the cellulose acylate films of Examples 1 to 10 underwent cooling treatment at lower than Tg and thermal relaxation treatment at Tg or higher after stretching treatment, thereby showing satisfactory percent of dimensional change by heat and bowing.

In Example 1, L2/L1 was 0.8, while in Example 2, the length of cooling zone was smaller than that of Example 1, and L2/L1 was as small as 0.2. In Example 9, the length of the cooling zone was further smaller, and L2/L1 was as small as less than 0.2. The results confirm that bowing is a little increased with the decrease in L2/L1. Thus, L2/L1 is preferably 0.2 or more and more preferably 0.5 or more.

In Example 3, the drawing ratio was 1.05, which was smaller than that of Example 1, while in Example 4, the drawing ratio was 2.5, which was larger than that of Example 1. Even when changing the drawing ratio between 1 to 2.5, cellulose acylate films showing satisfactory percent of dimensional change by heat and bowing were always obtained. In Example 10, the drawing ratio was as large as 3, and in this case, the percent of dimensional change by heat and bowing were a little increased. The percent of dimensional change by heat and bowing tend to be a little increased with increase in drawing ratio, and thus, the drawing ratio is preferably 2.5 or smaller.

In Example 5, the temperature of the cooling zone was lower than that in Example 1, while in Example 6, the temperature of the cooling zone was higher than that in Example 1. Even when changing the temperature of the cooling zone within the temperature range lower than Tg, good results were always obtained.

In Example 7, the substitution degrees of acyl groups were A=0.1 and B=2.85 compared with those in Example 1. This confirmed that even when changing the substitution degrees of acyl groups within the range of: 2.0≦A+B≦3.0, 0≦A≦2.0, and 1.2≦B≦2.9, good results were always obtained in terms of Re, Rth developing properties, percent of dimensional change by heat and bowing. In Example 8, the substitution degree of acetyl group was A=0.7, while each of the substitution degrees of propionyl, butylyl, pentanoyl and hexanoyl groups was 0.5 and the sum of them was 2.0. This confirmed that as long as the sum B of the substitution degrees of propionyl, butylyl, pentanoyl and hexanoyl groups satisfied the above expression, good results were obtained in terms of Re, Rth developing properties, percent of dimensional change by heat and bowing.

On the other hand, in Comparative Example 1, the temperature of the cooling zone was 130° C. (in other words, cooling treatment was not performed), as a result, a large scale of bowing occurred. In Comparative Example 2, the temperature of the relaxation zone was 100° C. (in other words, heat relaxation treatment was not performed), as a result, the percent of thermoplastic dimensional change was −1.2%.

### [Preparation of Sheet Polarizer]

### (1) Surface Treatment

The stretched cellulose acylate films were saponified by either one of the following processes.

### (i) Coating-Saponification Process

To 80 parts by weight of isopropanol, 20 parts by weight of water was added, and KOH was dissolved in the above mixed solution so that the normality of the solution was 1.5. The temperature of the solution was adjusted to 60° C. and used as a saponifying solution. The saponifying solution was coated on the cellulose acylate film at 60° C. in an amount of 10 g/m² to allow the cellulose acylate film to undergo saponification for 1 minute. The saponified cellulose acylate film was cleaned by spraying warm water at 50° C. at a spraying rate of 10 L/m²·min for 1 minute.

### (ii) Immersion-Saponification Process

As a saponifying solution, 1.5 N NaOH aqueous solution was used. The temperature of the solution was adjusted to 60° C., and each cellulose acylate film was immersed in the solution for 2 minutes. Then, the film was immersed in 0.1 N aqueous solution of sulfuric acid for 30 seconds and passed through a water washing bath.

### (2) Preparation of Polarizing Layer

A polarizing layer 20 μm thick was prepared by creating a difference in peripheral velocity between two pairs of nip rolls to carry out stretching in the longitudinal direction in accordance with Example 1 described in Japanese Patent Application Laid-Open No. 2001-141926. A polarizing layer right after film formation and stretching and a polarizing layer kept at 80° C. for one month were prepared. A polarizing layer was also prepared by carrying out stretching in such a manner that the stretching axis was tilted at 45°, just like in Example 1 described in Japanese Patent Application Laid-Open No. 2002-86554, but the evaluations were the same as those of the sheet polarizer prepared using the above described polarizing layer.

### (3) Lamination

Each of the polarizing layer right after the stretching as above (a fresh product) and the polarizing layer kept at 80° C. for one month after the stretching (an over time product) was held between a stretched cellulose acylate film having undergone saponification (phase difference plate) and a sheet polarizer protective film having undergone saponification (trade name: Fujitack). When the phase difference plate was a cellulose acylate film, the adhesion of the phase difference plate and the polarizing layer was made using a 3% PVA aqueous solution (PVA-117H, manufactured by Kuraray Co., Ltd.), as an adhesive. And when the phase difference plate is a film other than a cellulose acylate film, an epoxy adhesive was used for laminations. The adhesion of Fujitack and the polarizing layer was made using the above PVA aqueous solution as an adhesive. The lamination was made so that the angle between the polarization axis and the longitudinal direction of the phase difference plate is 45 degrees. Each of the sheets of polarizer thus obtained was installed in a 20-inch VA-mode liquid crystal display, as described in FIGS. 2 to 9 of Japanese Patent Application Laid-Open No. 2000-154261 so as to place the phase difference plate on the liquid crystal side and Fujitack on the outer side (visual observation side). The performance of the liquid crystal display in which the sheet of polarizer using the fresh product was installed was compared with that of the liquid crystal display in which the sheet of polarizer using the over time product was installed. The films were evaluated by visual observation of color nonuniformity, based on the percentage of the area where color nonuniformity occurred to the whole area. The evaluations confirmed that the performance of the liquid crystal display in which the present invention was embodied was good.

### [Preparation of Optical Compensation Film]

Optical compensation films were prepared using the stretched cellulose acylate films of the present invention, instead of the cellulose acetate film of Example 1 described in Japanese Patent Application Laid-Open No. 11-316378 whose surface was coated with a liquid crystal layer. A comparison was made between the optical compensation film prepared using the cellulose acylate film right after forming and stretching (a fresh product) and the optical compensation film prepared using the cellulose acylate film kept at 80° C. for 1 month (an over time product). The optical compensation films were evaluated by visual observation of the color nonuniformity, based on the percentage of the area where color nonuniformity occurred to the whole area. The evaluations confirmed that the optical compensation film which was prepared using the stretched cellulose acylate film manufactured using the cellulose acylate film of the present invention had a good performance.

The optical compensation film prepared using the stretched cellulose acylate film of the present invention, instead of the cellulose acetate film of Example 1 described in Japanese Patent Application Laid-Open No. 7-333433 whose surface was coated with a liquid crystal layer, also had a good performance.

On the other hand, in the optical compensation films prepared using a cellulose acylate film that did not satisfy the requirements of the present invention, the optical properties were deteriorated. The deterioration was remarkable particularly in the optical compensation film prepared in accordance with Example 1 of Japanese Patent Application Laid-Open No. 2002-311240.

### [Preparation of Low Reflection Film]

Low reflection films were prepared using the stretched cellulose acylate films of the present invention in accordance with Example 47 described in Journal of Technical Disclosure (Laid-Open No. 2001-1745) issued by Japan Institute of Invention and Innovation. The prepared low reflection films had a good optical performance.

### [Preparation of Liquid Crystal Display Device]

The above described sheets of polarizer of the present invention were used in the liquid crystal display described in Example 1 of Japanese Patent Application Laid-Open No. 10-48420, for the optically anisotropic layer containing discotic liquid crystal molecules and for the alignment film whose surface was coated with polyvinyl alcohol described in Example 1 of Japanese Patent Application Laid-Open No. 9-26572, in the 20-inch VA-mode liquid crystal display described in FIGS. 2 to 9 of Japanese Patent Application Laid-Open No. 2000-154261, in the 20-inch OCB-mode liquid crystal display described in FIGS. 10 to 15 of Japanese Patent Application Laid-Open No. 2000-154261, and in the IPS-mode liquid crystal display described in FIG. 11 of Japanese Patent Application Laid-Open No. 2004-12731. Furthermore, the low reflection films of the present invention were laminated on the outermost surface of the above described liquid crystal displays and evaluation was conducted. Good liquid crystal display devices were obtained.

1. A method for producing a thermoplastic film, comprising a stretching step of stretching a thermoplastic film across the width, wherein
in the stretching step, a stretching treatment which stretches the thermoplastic film, a cooling treatment which cools the stretched thermoplastic film at a temperature lower than the glass transition temperature Tg, and a thermal relaxation treatment which thermally relaxes the cooled thermoplastic film at a temperature of Tg or higher are consecutively conducted.

2. The method for producing a thermoplastic film according to claim 1, wherein
where L1 represents a length of the stretching zone, in which the stretching treatment is conducted, in the thermoplastic film's running direction and L2 represents a length of the cooling zone, in which the cooling treatment is conducted, in the thermoplastic film's running direction, L2/L1 is 0.2 or more and 20 or less.

3. The method for producing a thermoplastic film according to claim 1, wherein
the thermal relaxation treatment shrinks the width of the thermoplastic film by 0 to 30%.

4. The method for producing a thermoplastic film according to claim 1, wherein
in the thermoplastic film having undergone the thermal relaxation treatment, the percent of dimensional change, after it is kept at 60° C. and 90% rh for 24 hours, is ±1% or less both across the width and across the length.

5. The method for producing a thermoplastic film according to claim 1, wherein
the thermoplastic film is a saturated norbornene film.

6. The method for producing a thermoplastic film according to claim 1, wherein
the thermoplastic film is a cellulose acylate film formed using a cellulose acylate resin.

7. The method for producing a thermoplastic film according to claim 6, wherein
the cellulose acylate resin is such that the substitution degree of its acylate group satisfies the following expressions:
2.0≦A+B≦3.0
0≦A≦2.0
1.2≦B≦2.9
where A represents the substitution degree of an acetyl group, and B represents the sum of the substitution degrees of propionyl, butylyl, pentanoyl and hexanoyl groups.

8. The method for producing a thermoplastic film according to claim 1, wherein
the stretching treatment is conducted, while holding the edges of the thermoplastic film across the width, to give an at least from 1.0 times or more and 2.5 times or less width.

9. The method for producing a thermoplastic film according to claim 2, wherein
the thermal relaxation treatment shrinks the width of the thermoplastic film by 0 to 30%.

10. The method for producing a thermoplastic film according to claim 2, wherein
in the thermoplastic film having undergone the thermal relaxation treatment, the percent of dimensional change, after it is kept at 60° C. and 90% rh for 24 hours, is ±1% or less both across the width and across the length.

11. The method for producing a thermoplastic film according to claim 3, wherein
in the thermoplastic film having undergone the thermal relaxation treatment, the percent of dimensional change, after it is kept at 60° C. and 90% rh for 24 hours, is ±1% or less both across the width and across the length.

12. The method for producing a thermoplastic film according to claim 2, wherein
the thermoplastic film is a saturated norbornene film.

13. The method for producing a thermoplastic film according to claim 3, wherein
the thermoplastic film is a saturated norbornene film.

14. The method for producing a thermoplastic film according to claim 4, wherein
the thermoplastic film is a saturated norbornene film.

15. The method for producing a thermoplastic film according to claim 2, wherein
the thermoplastic film is a cellulose acylate film formed using a cellulose acylate resin.

16. The method for producing a thermoplastic film according to claim 3, wherein
the thermoplastic film is a cellulose acylate film formed using a cellulose acylate resin.

17. The method for producing a thermoplastic film according to claim 4, wherein
the thermoplastic film is a cellulose acylate film formed using a cellulose acylate resin.

18. The method for producing a thermoplastic film according to claim 2, wherein
the stretching treatment is conducted, while holding the edges of the thermoplastic film across the width, to give an at least from 1.0 times or more and 2.5 times or less width.

19. The method for producing a thermoplastic film according to claim 3, wherein
the stretching treatment is conducted, while holding the edges of the thermoplastic film across the width, to give an at least from 1.0 times or more and 2.5 times or less width.

20. The method for producing a thermoplastic film according to claim 4, wherein
the stretching treatment is conducted, while holding the edges of the thermoplastic film across the width, to give an at least from 1.0 times or more and 2.5 times or less width.
